(19) United States
(12) Patent Application Publication
(10) Pub. No.: US 2026/0127979 A1
(43) Pub. Date: May 7, 2026

(54) RECIPE GENERATION WITH MACHINE LEARNING AND SYNCHRONIZED RECIPE USE WITH CONNECTED KITCHEN APPLIANCES

(71) Applicant: Adaptics Limited, Dublin (IE)

(72) Inventors: Timothy James REDFERN, Clonbur (IE); Benjamin HARRIS, Dublin (IE); Graham O’SULLIVAN, Naas (IE); Adam BERMINGHAM, Dublin (IE)

(73) Assignee: Adaptics Limited, Dublin (IE)

(21) Appl. No.: 19/114,310

(22) PCT Filed: Sep. 27, 2023
(86) PCT No.: PCT/EP2023/076766

§ 371 Date: Mar. 21, 2025

Related U.S. Application Data
(60) Provisional application No. 63/410,340, filed on Sep. 27, 2022.
(60) Provisional application No. 63/527,435, filed on Jul. 18, 2023.

(51) Int. Cl. G09B 19/00; A23L 5/00; G06N 5/022

(52) U.S. Cl. CPC G09B 19/0092; A23L 5/00; G06N 5/022

(57) ABSTRACT

In a system in which a recipe is stored on a recipe framework, a method includes a recipe program presenting recipe information to a user using a device interface on a first device and/or an appliance interface of a first appliance; tracking user interactions with the recipe program via the device or appliance interface; monitoring progress and state of the recipe; and maintaining in the recipe framework, a version of the progress and state of the recipe. Responsive to the user switching to a second device or appliance while the recipe is in progress, presenting recipe information on the second device or appliance based on the version of the progress and state of the recipe maintained in the recipe framework, where the second device or appliance obtains the version of the progress and state from the recipe framework. The recipe was generated by one or more machine-learning algorithms.

### RELATED AND/OR INCORPORATED PATENTS AND PATENT APPLICATIONS

This application claims the benefit of U.S. provisional patent applications (i) U.S. Provisional patent application No. 63/410,340, filed Sep. 27, 2022, for “SYNCHRONIZED RECIPE USE WITH CONNECTED KITCHEN APPLIANCES,” and (ii) 63/527,435, filed Jul. 18, 2023, for “RECIPE GENERATION WITH MACHINE LEARNING AND SYNCHRONIZED RECIPE USE WITH CONNECTED KITCHEN APPLIANCES,” the entire contents of which are hereby fully incorporated herein by reference for all purposes. The entire contents of U.S. Pat. No. 11,631,010, issued Apr. 18, 2023, are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### APPENDICES

This application includes the following appendices, which are part of this application:
Appendix A: Example of Schema.org recipe in JSON-LD format;
Appendix B: Examples of Step Extraction; and
Appendix C: Example connected (smart) recipe.

### FIELD OF THE INVENTION

Aspects of this invention relate to improving user experiences with connected kitchen appliances. More specifically, aspects of the invention relate to using machine learning (ML) to generate recipes usable on connected kitchen appliances.

### BACKGROUND

Home chefs are now offered many innovative kitchen appliances with multiple cooking functions and time-saving features. However, it is not always easy for the home user to understand how to use these appliances beyond the limited range of sample recipes developed and distributed by the manufacturer.

Connecting these appliances to home networks/the internet is a popular option with both consumers and manufacturers, with the potential to link recipe discovery, ingredient supply, and cooking in a seamless guided journey. However, there is a tendency that connected appliances each exist in a separate ecosystem with their user interface, mobile app, and recipes.

One of the biggest problems facing the owners and manufacturers of connected kitchen appliances is the availability of relevant recipe content. Home chefs want the freedom to discover recipes from many sources, with the confidence to know how to make the best use of their appliances and the convenience of applying them to a connected guided cooking flow. Kitchen appliance manufacturers want to avoid developing and testing recipes for every appliance they sell.

It is an object hereof to provide recipes usable with connected kitchen appliances.

### SUMMARY

Aspects of the present invention are specified in the claims and the below description. Preferred embodiments are particularly specified in the dependent claims and the description of various embodiments.

In some aspects, embodiments provide a machine-learning pipeline that allows recipes as human-readable text to be processed to recognize cooking entities from a curated knowledge graph. Once imported, recipes are annotated with machine-readable information: for example, ingredients and appliance instructions, allowing the recipe to connect the user with automated ingredient and appliance features and other smart algorithms.

The recipe pipeline may fulfill the needs of a cross-brand connected kitchen platform designed to assist users with recipe discovery, recipe customization, ingredient management, following recipes, and controlling automated appliances.

When using the platform, recipes may be submitted to the machine learning pipeline, allowing ingredient, appliance, and algorithm features to be used with recipes chosen by the user at runtime.

The platform may also represent user actions and store user activity history centrally. Representing the user with a centrally stored profile allows user actions to be synchronized between mobile devices, appliances, and other recipe clients, affording flexibility for the user.

The digital recipe knowledge graph allows the implementation of smart kitchen algorithms allowing the platform to apply culinary expertise automatically to adapt recipes to achieve the best results. Examples of these algorithms include appliance capability resolution, recipe scaling, ingredient substitutions, calibration of appliances, recipes, and ingredients, algorithms using nutritional information, and recipe recommendation.

In some other aspects, embodiments provide a knowledge graph of culinary processes, ingredients, and measurement units. Appliance capabilities may be mapped to the knowledge graph, and the machine learning pipeline may be trained to annotate recipes via the knowledge graph.

In some other embodiments, the machine learning pipeline may generate ingredient lists, step descriptions, and step metadata (e.g., ingredients and appliance data) required for guided cooking. In the case of appliance step data, this may involve using three trained models:
A first model recognizes culinary techniques and maps them to a knowledge graph of capabilities that a kitchen appliance can fulfill (e.g., bake) to annotate the recipe with capability events. This model may also find related parameters (e.g., temperature, speed, time, and power).
A second model for relation classifications, i.e., which parameters relate to which capabilities.
A third model maps ambiguous capabilities (e.g., ‘heat’) to the capabilities knowledge graph (e.g., ‘cook,’ ‘bake,’ etc.)

In some aspects, the platform comprises a collection of databases and applications that connect users (via their client devices) with appliances, external content, and third-party services. Implementation of these services allows access not limited by the number of appliances, recipes, users, or client devices. This provides the required scalable architecture, allowing the processing of numerous client requests, database transactions, and processing (algorithms and pipelines) to be performed in parallel without affecting the time taken to respond to the user.

In some aspects, the platform receives and acts on streams of events coming from appliances, users, and third-party services. This may be facilitated by using a standard canonical format for events which represents a standard way for clients to talk to appliances. The design of the events pipeline recognizes the value of understanding the cooking that occurs on the platform. Thus, all events received are stored to facilitate mining the event store for insights.

Representation of user activity and history in a centrally stored profile supports the synchronization of client devices discovering and following recipes for a user. For example, mobile applications (apps), appliances with recipe-capable touchscreen interfaces, smart TVs, voice assistants, and third-party smart home frameworks may be used interchangeably and/or simultaneously. This allows the user to use the nearest device to hand, interact by voice, e.g., when their hands are occupied, and follow instructions wherever is most convenient, for example, while operating an appliance.

A system of one or more computers can be configured to perform particular operations or actions by virtue of having software, firmware, hardware, or a combination of them installed on the system that, in operation, causes or cause the system to perform the actions. One or more computer programs can be configured to perform particular operations or actions by virtue of including instructions that, when executed by the data processing apparatus, cause the apparatus to perform the actions.

One general aspect includes a method in a system in which a recipe is stored on a recipe framework, and where a user has one or more devices and one or more appliances. The method also includes a recipe program presenting recipe information to the user using a device interface on a first of the one or more devices and/or on an appliance interface of a first appliance of the one or more appliances. The method also includes tracking user interactions with the recipe program via the device interface or the appliance interface. The method also includes monitoring the progress and state of the recipe. The method also includes, based on the monitoring, maintaining in the recipe framework a version of the progress and state of the recipe. The method also includes, while the recipe is in progress, and in response to the user switching to a second device of the one or more devices and/or to a second appliance of the one or more appliances, presenting recipe information on the second device and/or on the second appliance based on the version of the progress and state of the recipe maintained in the recipe framework, where the second device or second appliance obtains the version of the progress and state from the recipe framework. Other embodiments of this aspect include corresponding computer systems, apparatus, and computer programs recorded on one or more computer storage devices, each configured to perform the actions of the methods.

Implementations may include one or more of the following features, alone or in combination(s):

The method where the version of the progress and state of the recipe that is maintained in the recipe framework is a true version (or is considered a true version) of the progress and state of the recipe. The recipe framework is accessible via one or more interfaces, and where a device or appliance obtains the true version of the progress and state from the recipe framework via the one or more interfaces. The recipe framework, where the true version of the progress and state of the recipe is based on received streams of events and/or state data coming from the one or more devices and/or the one or more appliances. State data from an appliance includes information about the current state of the appliance. If there is a discrepancy between versions of the progress and state of the recipe, the progress and state maintained by the recipe framework will govern. The recipe may include a list of one or more ingredients and a list of recipe steps, and where the state of the progress and state of the recipe may include information about which recipe step or steps have been completed. The recipe framework determines which one or more appliances to use for the recipe based on information about appliances available to the user. A determination of which appliances to use for the recipe is made when the user selects the recipe, and using user data maintained by the recipe framework, the user data, including appliance data.

The method may include performing one or more of the following acts: (i) calibration; (ii) recipe scaling; (iii) ingredient substitutions; (iv) nutritional information determination; (v) recommendations; and (vi) capability resolution. The acts are performed before steps and/or ingredients of the recipe are determined. The recipe determines which of the one or more appliances are to be used, and where a determination of which of the one or more appliances are to be used is made after the acts are performed. The one or more devices are selected from a personal computer, a cell phone, a tablet computer, a desktop computer, a TV, a smartwatch, a voice assistant, or a kitchen appliance with a user interface capable of following recipes; and where the one or more appliances are selected from cooking and food preparation appliances. The recipe was generated by one or more machine-learning algorithms. The recipe is a connected recipe that was generated based on an initial recipe. The initial recipe was a structured recipe, including initial recipe step data, and/or initial recipe ingredient data, and/or initial recipe appliance data. The connected recipe is a structured recipe and includes connected recipe step data and/or connected recipe ingredient data, and/or connected recipe appliance data. The connected recipe also includes miscellaneous connected recipe data, including connected recipe metadata. The connected recipe step data and/or connected recipe ingredient data were determined by the one or more machine-learning algorithms based on the initial recipe step data and/or initial recipe ingredient data and using a knowledge graph of culinary processes, ingredients, and measurement units.

The one or more machine-learning algorithms may include a machine-learning (ML) pipeline. The ML pipeline generates the connected recipe step data and/or the connected recipe ingredient data, and/or the connected recipe appliance data. The ML pipeline includes a first model that recognizes culinary techniques and maps them to a knowledge graph of capabilities an appliance can fulfill to annotate the connected recipe with capability events. The first model finds appliance-related parameters. The appliance-related parameters include one or more of temperature, speed, time, and/or power. The ML pipeline further includes a second model for relation classifications to determine which parameters relate to which capabilities. The ML pipeline further includes a third model that maps ambiguous capabilities to the knowledge graph of capabilities.

Implementations of the described techniques may include hardware, a method or process, or computer software on a computer-accessible medium.

The above features and additional details of the invention are described further in the examples herein, which are intended to further illustrate the invention but are not intended to limit its scope in any way.

### BRIEF DESCRIPTION OF THE DRAWINGS

Objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification.

FIGS. 1A, 1B, 1C, and 1D depict aspects of an exemplary system employing a recipe framework according to exemplary embodiments hereof;

FIGS. 2A-2B depict aspects of devices and appliances, respectively;

FIGS. 3A, 3B, and 3C depict aspects of recipe data, appliance data, and user data, respectively, according to exemplary embodiments hereof;

FIGS. 4A-4B depict aspects of a machine learning (ML) framework according to exemplary embodiments hereof;

FIGS. 5A-5B depict aspects of using a recipe framework according to exemplary embodiments hereof;

FIGS. 6A, 6B, 6C, 6D, and 6E show examples of ground truth semantic labels overlaid on plain recipes;

FIGS. 6F-6R are an example of an ingredient section in a recipe with semantic information overlaid; and

FIG. 7 is a visualization of standard cooking capabilities according to exemplary embodiments hereof.

FIG. 8 depicts aspects of computing according to exemplary embodiments hereof.

### DETAILED DESCRIPTION OF EXEMPLARY EMBODIMENTS

### Glossary and Abbreviations

As used herein, unless used otherwise, the following terms or abbreviations have the following meanings:
API means Application Programming Interface.
ML means machine learning.
NLP means natural language processing.
BERT refers to Bidirectional Encoder Representations from Transformers, a transformer-based machine learning technique for natural language processing (NLP) pre-training. RBERT is an R implementation of the Python package BERT.
GENRE refers to a library for autoregressive entity retrieval (see De Cao, Nicola, et al. “Multilingual Autoregressive Entity Linking.” Transactions of the Association for Computational Linguistics 10 (2022): 274-290).
NER means named entity recognition.
WIP means work in process.
JSON-LD (JSON for Linked Data) is a method of encoding linked data using JSON (JavaScript Object Notation).
SPARQL (SPARQL Protocol and RDF Query Language) is a semantic query language for databases, able to retrieve and manipulate data stored in Resource Description Framework (RDF) format.

The term “mechanism,” as used herein, refers to any device(s), process(es), service(s), or combination thereof. A mechanism may be implemented in hardware, software, firmware, using a special-purpose device, or any combination thereof. A mechanism may be integrated into a single device, or it may be distributed over multiple devices. The various components of a mechanism may be co-located or distributed. The mechanism may be formed from other mechanisms. In general, as used herein, the term “mechanism” may thus be considered shorthand for the term device(s) and/or process(es) and/or service(s).

### DESCRIPTION

### Overview and Structure

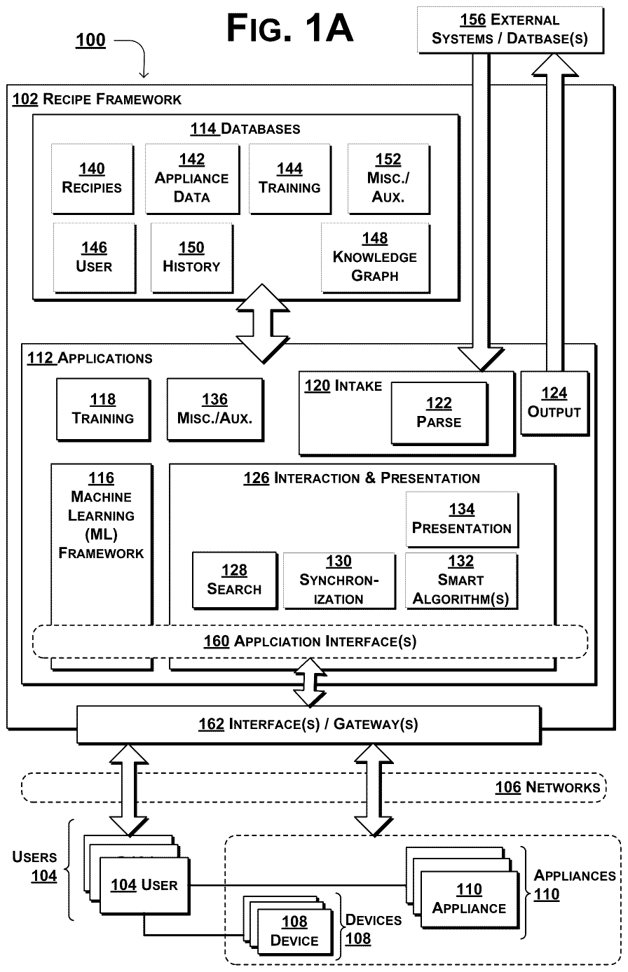

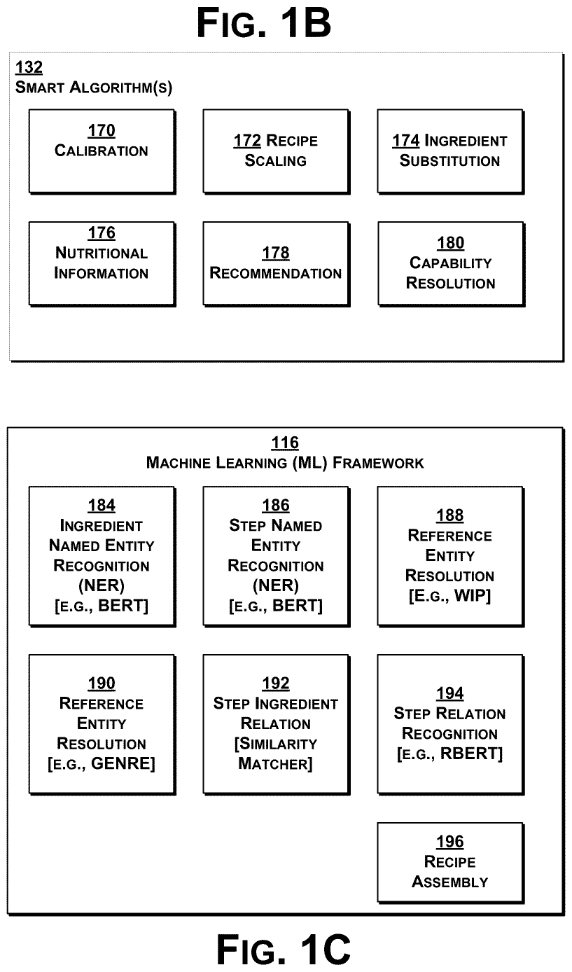

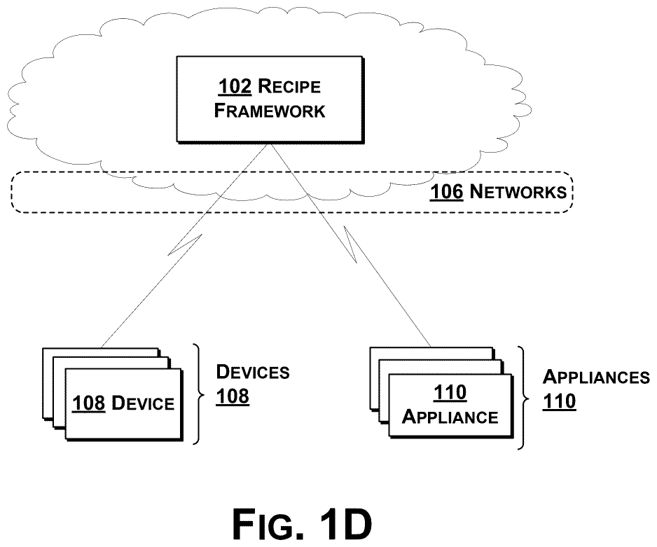

FIG. 1A shows aspects of an exemplary system 100 employing a recipe framework 102 described below in greater detail. As shown in the drawing, a recipe framework 102 may be accessed by users 104, e.g., via one or more networks 106 (e.g., the Internet). Different types of users are contemplated. For example, the users 104 may be appliance manufacturers, appliance end users, or others. Each user 104 has one or more devices 108 and one or more appliances 110 associated therewith. These devices 108 and appliances 110 are discussed in greater detail below. However, each device 108 and appliance 110 includes (or is) a computing device (also discussed in greater detail below), and users 104 may access the recipe framework 102 using one or more of their devices 108 and/or appliances 110, as known in the art.

As shown in FIG. 1A, the recipe framework 102 (sometimes referred to as the recipe system or platform or backend) may comprise various mechanisms or applications 112 (e.g., software applications) and one or more databases 114, described below. The applications 112 may generally interact with the one or more databases 114.

The database(s) 114 may comprise multiple separate or integrated databases, at least some of which may be distributed. The database(s) 114 may be implemented in any manner, and when made up of more than one database, the various databases need not all be implemented in the same manner. The system is not limited by the nature or location of the database(s) 114 or how they are implemented.

Each application 112 is essentially a mechanism (as defined above, e.g., a software application) that may provide one or more services (internal or external) via an appropriate interface. Although shown as separate mechanisms for this description, it should be appreciated that some or all of the various applications 112 may be combined. Similarly, a mechanism shown here as a single mechanism may comprise multiple component mechanisms. The various applications 112 may be implemented in any manner and need not all be implemented in the same manner (e.g., with the same languages or interfaces, or protocols).

The applications 112 may include one or more of the following:
Machine learning framework 116 (which forms or comprises a machine learning framework)
Training mechanism(s) 118
Intake mechanism(s) 120, which may include parse mechanism(s) 122
Output mechanism(s) 124
Interaction and presentation mechanism(s) 126, which may include search mechanism(s) 128, synchronization mechanism(s) 130, one or more smart mechanism(s) 132, and presentation mechanism(s) 134.
Miscellaneous/auxiliary mechanisms 136

Note that the above list of applications/mechanisms is exemplary and is not intended to limit the scope of the system 100 in any way. Those of ordinary skill in the art will appreciate and understand, upon reading this description, that the system 100 may include any other types of data processing mechanisms and/or other types of mechanisms that may be necessary for the system 100 to generally perform its functionalities as described herein. In addition, as should be appreciated, embodiments or implementations of the system 100 need not include all of the mechanisms listed, and some or all of the mechanisms may be optional.

The database(s) 114 may include one or more of the following database(s):
Recipes database(s) 140
Appliance database(s) 142
System training database(s) 144
User database(s) 146
Knowledge graph database(s) 148
History database(s) 150
Miscellaneous and auxiliary database(s) 152

The above list of databases is exemplary and is not intended to limit the scope of the system 100 in any way.

As shown in FIG. 1A, the recipe system/framework 102 may access one or more external systems and databases 156. This access may include access via intake mechanism(s) 120, which may access external systems to obtain data therefrom. Access via output mechanism(s) 124 may be used to provide information (e.g., annotated recipes) to the external systems and/or databases 156.

Various applications 112 in the recipe system/framework 102 may be externally accessible via interface(s) 160. These interfaces 160 may be provided in the form of APIs or the like, made accessible to users 104 via one or more gateways and interfaces 162. For example, the search mechanism(s) 128 may provide APIs thereto (via the interface(s) 160). The recipe system/framework 102 may provide external access to aspects of the system (to users 104) via appropriate gateways and interfaces 162 (e.g., via a web-based mechanism and/or a mechanism running on a user's device).

With reference now to FIG. 1B, the smart algorithm(s) 132 may include one or more of the following:
Calibration mechanism(s) 170
Scaling mechanism(s) 172
Ingredient substitution mechanism(s) 174
Nutritional information mechanism(s) 176
Recommendation mechanism(s) 178

As should be appreciated, different and/or other mechanisms may be included in the smart algorithm(s) 132. Furthermore, although shown in the drawing and described as separate mechanisms, some or all of the smart algorithms 132 may be combined or integrated into other such mechanisms.

With reference now to FIG. 1C, the machine learning framework 116 may include one or more of the following:
Ingredient named entity recognition (NER) mechanism(s) 184
Step named entity recognition (NER) mechanism(s) 186
Reference entity resolution [WIP] mechanism(s) 188
Reference entity resolution (e.g., GENRE) mechanism(s) 190
Step ingredient relation (similarity matcher) mechanism(s) 192
Step relation recognition (e.g., RBERT) mechanism(s) 194
Recipe assembly mechanism(s) 196

The Ingredient NER mechanism(s) 184 (e.g., BERT), Step NER mechanism(s) 186 (e.g., BERT), reference entity resolution mechanism(s) 188 (e.g., WIP), reference entity resolution mechanism(s) 190 (e.g., GENRE), Step ingredient relation mechanism(s) 192, and Step relation recognition mechanism(s) 194 (e.g., RBERT) are machine learning (ML) models, trained to perform their respective functions.

In a present implementation, the step relation recognition mechanism(s) 194 may use RBERT, and the reference entity resolution mechanism(s) 190 may use GENRE. As noted above (in the Glossary and Abbreviations), RBERT is an implementation of the BERT (Bidirectional Encoder Representations from Transformers), a transformer-based machine learning technique for natural language processing (NLP) pre-training. BERT is an encoder based on a deep-learning transformer architecture. RBERT is a modification to BERT, which captures additional entity-relationship information and can thus be used to identify relations of different types between different entities. GENRE is a library for autoregressive entity retrieval, providing a machine learning model architecture for matching found entities in entities to a knowledge base of entities, that is, an architecture for entity disambiguation. Those of skill in the art will understand, upon reading this description, that different and/or other mechanisms may be used with or in place of RBERT (and BERT) and/or GENRE.

As should be appreciated, the recipe framework 102 comprises various mechanisms that may be implemented on one or more computer systems (described in greater detail below). The one or more computer systems that make up the recipe framework 102 may be co-located but need not. The one or more computer systems that make up the recipe framework 102 need not be homogeneous. While specially programmed general-purpose computers may be used to implement some or all of the recipe framework 102, those of skill in the art will understand, upon reading this description, that some aspects (e.g., the ML framework 116) may be implemented using specialized hardware or processors.

### Cloud Access

From the point of view of devices 108 or appliances 110, the recipe framework 102 may sometimes be referred to as being in the cloud, and accessing the recipe framework 102 may be referred to as cloud access. For example, as shown in FIG. 1D, the devices 108 and appliances 110 access the recipe framework 102 in the cloud. The access may be via one or more networks 106, some of which may also be in the cloud.

### User Devices & Appliances

As noted above, a user 104 may have one or more devices 108 and one or more appliances 110 associated therewith.

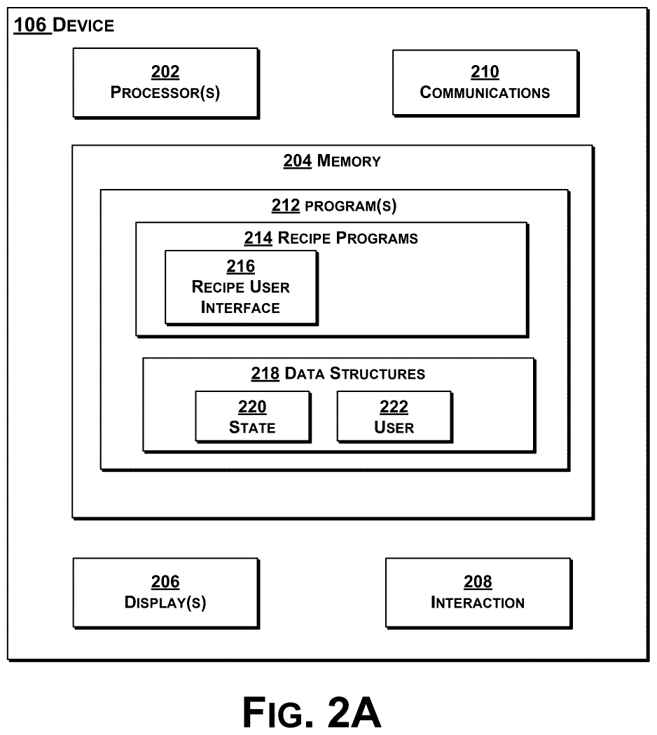

With reference to FIG. 2A, a user device 108 is essentially a computing device and includes one or more processors 202, memory 204, a display 206, and one or more interaction mechanism(s) 208 (e.g., a keyboard or the like). The interaction mechanism(s) 208 may be integrated into the display (e.g., a touch screen, virtual keyboard, or the like). The device also includes communications mechanism(s) 210 that support communication with external devices and systems. For example, the communications mechanism(s) 210 may support wired or wireless communication (e.g., Bluetooth, WiFi, Ethernet, mobile, cellular, etc.) with other devices 108 and appliances 110. The communications mechanism(s) 210 may also support communication with the recipe framework 102, e.g., via the network(s) 106.

The device's memory 204 may store programs 212, including recipe programs 214. The recipe programs 214 may include or support recipe user interfaces 216. The memory may also store data 218 supporting the programs 212. The data 218 may include data 218 for the recipe programs 214, which may include state data 220 and user data 222.

A device 108 may be, e.g., a personal computer, a cell phone, a tablet computer, a desktop computer, or the like. A device may be standalone or integrated into other devices (e.g., a set-top box, an appliance, or the like).

With reference to FIG. 2B, an appliance 110 includes one or more mechanism(s) 226 and sensors 228 supporting the appliance's functionality (as an appliance). For example, if the appliance is an oven, the mechanisms 226 and sensors 228 support the operation of the oven (as an oven). The appliance may also include one or more processors 232, memory 234, a display 236, and one or more interaction mechanism(s) 238 (e.g., a keypad, buttons, or the like). The interaction mechanism(s) 238 may be integrated into a display (e.g., a touch screen, virtual keyboard, or the like). The device also includes communications mechanism(s) 240 that support communication with external devices and systems. For example, the communications mechanism(s) 240 may support wired or wireless communication (e.g., Bluetooth, WiFi, Ethernet, etc.) with other devices 108 and appliances 110. The communications mechanism(s) 240 may also support communication with the recipe framework 102, e.g., via the network(s) 106.

The appliance's memory 234 may store programs 242, including recipe programs 244. The recipe programs 244 may include or support recipe user interfaces 246. The memory may also store data 248 supporting the programs 242. The data 248 may include data for the recipe programs 244, which may include state data 250 and user data 252.

An appliance 110 may be, e.g., an oven, a pressure cooker, or the like. An appliance may be standalone, or it may be integrated into other appliances.

### Databases and Data

### Recipes and Recipe Data

As explained in detail below, the recipe framework 102 transforms a textual (“plain old”) recipe or semi-structured (e.g., schema.org format JSON-LD) recipe into a structured recipe, referred to herein as a “connected recipe.”

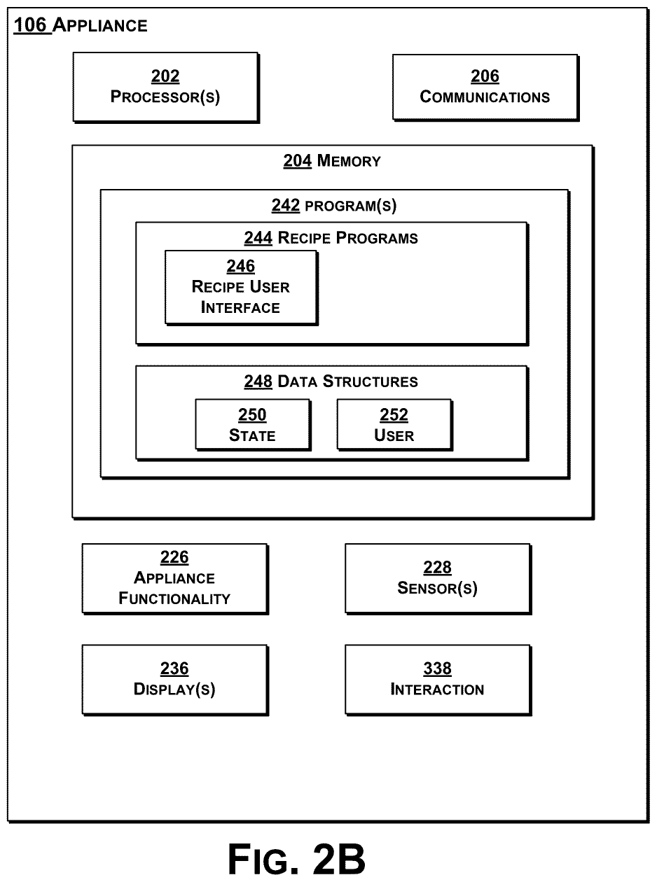

FIG. 3A shows an exemplary logical organization of recipe data 300 (e.g., in recipes database(s) 140 in FIG. 1A, recipe data 216 in the device 108 in FIG. 2A, and recipe data 246 in the appliance 110 in FIG. 2B). With reference to FIG. 3A, recipe data 300 may include plain recipe data 302 (which may be semi-structured, e.g., using JSON-LD), connected recipe data 304, and miscellaneous recipe data 306. The connected recipe data 304 preferably contains recipes structured by the recipe framework 102. These connected recipes may have corresponding plain recipes in the plain recipe data 302.

The plain recipe data 302 may include plain recipe step data 308, plain recipe ingredient data 310, plain recipe appliance(s) data 312, and other miscellaneous plain recipe data 314.

The connected recipe data 304 may include connected recipe step data 316, connected recipe ingredient data 318, connected recipe appliance(s) data 320, and other miscellaneous connected recipe data 322 (e.g., connected recipe metadata). The connected recipe metadata may include cooking capability requirements (e.g., “bake”) and appliance settings (e.g., “high”) from the knowledge graph (e.g., from knowledge graph(s) database(s) 148). Rather than requiring a specific manufacturer's appliance, this allows appliance capability resolution at runtime. The cooking capability, setting, and ingredients requirements belong to individual steps rather than the recipe as a whole.

### Connected Recipes

According to exemplary embodiments hereof, the recipe framework 102 produces so-called connected recipes from other recipes.

A connected recipe, according to exemplary embodiments hereof, is a machine-readable recipe with some or all of the following properties:
A connected recipe may be used, alone or in conjunction with other devices, to control connected appliances.
A connected recipe may also be structured or annotated to allow for and support recipe presentation to users on user devices and appliances.
A connected recipe may be normalized to remove ambiguity from a plain recipe
A connected recipe may be standardized to use standard measures and terminology
Other algorithms (e.g., smart algorithms 132) may use a connected recipe to transform the recipe (e.g., by scaling or ingredient substitution) or to determine information about the food produced by the recipe (e.g., nutritional information).

This list of properties of a connected recipe is not exclusive or limiting.

An example connected (smart) recipe is shown in Appendix C hereto.

### Appliance Data

FIG. 3B shows an exemplary logical organization of appliance data 330 (e.g., in appliance database(s) 142 in FIG. 1A). With reference to FIG. 3B, appliance data 330 may include manufacturer information 332, appliance capabilities 334, appliance state 336, appliance calibration data 337, and miscellaneous appliance data 338. An appliance's state data 336 may include information about the current state of the appliance (e.g., if the appliance is an oven, the appliance state data may include temperature data determined by the oven's thermometer (sensors 228)).

### User Data

FIG. 3C shows an exemplary logical organization of the user data 340 (e.g., in the user database(s) 146 in FIG. 1A, user data 222 in the device 108 in FIG. 2A, and user data 252 in the appliance 110 in FIG. 2B).

With reference to FIG. 3A, user data 340 may include:
user account information 342,
appliance data 344, including details about the appliances associated with the user,
recipe data 346, which may include the user's recipes,
device data 348, including details about the devices associated with the user,
state/progress data 350,
miscellaneous user data 352

A user's appliance data 344 is preferably appliance data 320, and from the appliance data 344, the recipe framework 102 can determine what appliances a user has and the capabilities of those devices.

A user's recipe data 346 is preferably recipe data 300 and may include recipes already processed by the recipe framework 102 (as described below). While a user's recipe data 346 may include unprocessed (plain) recipes, preferably, the user's recipe data 346 includes recipes that have been achieved via the ML pipeline.

If a user is in the process of using a recipe (preparing food with a recipe), the user's state/progress data 350 preferably provides an indication of what recipe is being used and the user's current progress/state within that recipe (e.g., what steps have already been completed).

### Recipe Generation

### The Machine Learning (ML) Framework

The connected recipes may be determined or generated by the machine learning (ML) framework 116. The ML framework operates on annotated recipes and produces corresponding connected recipes.

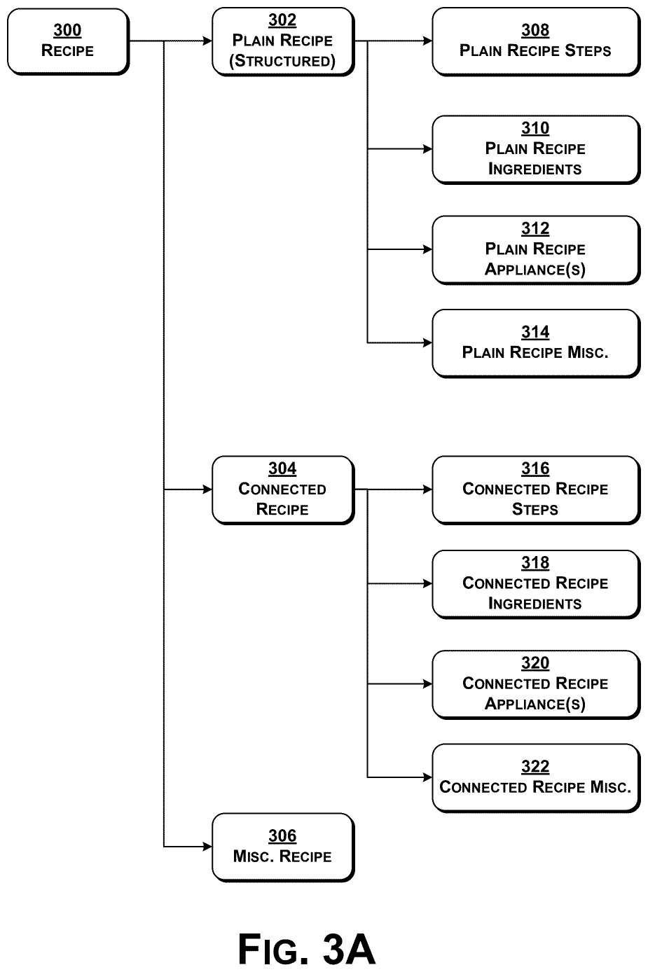

With reference to the flowchart in FIG. 4A, the ML framework 116 may take a recipe 400 as input. The recipe 400 is preferably a semi-structured recipe, e.g., obtained by the intake 120 from an external system or database 156 (e.g., a website or the like). The recipe 400 may be structured using JSON-LD (“Json for linking data”), a conventional way of providing structural recipes that supports sharing, indexing, searching, etc. The recipe 400 may include some or all of the plain recipe data 302 (FIG. 3A), including plain recipe step data 308, plain recipe ingredient data 310, plain recipe appliance data 312, and other miscellaneous plain recipe data 314.

The recipe 400 is parsed (at 410) to determine ingredients and steps. The ML framework 116 then finds the cooking entities in the recipe 400 (at 420) and maps the cooking entities to a cooking knowledge graph (at 430). The ML framework 116 then (at 440) recognizes entity relationships and then (at 450) creates a connected recipe 460.

The cooking knowledge graph is a linked data structure that captures the canonical or reference data used by all systems and processes on a system 100 employing the recipe framework 102. This data is centrally curated and is a single point of reference for concepts referred to in appliance configurations, user interfaces, and recipe data, for example. The core data in the graph is stored in an ontology materialized in a graph database. This data is made available as reference data via API and for queries, e.g., via SPARQL endpoints. Building on the ontology, projecting customer and recipe data into the graph enables personalization, substitution suggestion, search, and other use cases which rely on latent structure in the underlying data.

The connected recipe 460 created by the ML framework 116 may include some or all connected recipe data 304 (FIG. 3A), including connected recipe step data 316, connected recipe ingredient data 318, connected recipe appliance data 320, and other miscellaneous connected recipe data 322.

An exemplary implementation of this recipe generation process is shown in FIG. 4B, in which, first, a structured recipe 400 is parsed (at 412), implementing the parse 410 (FIG. 4A). The parsing may be performed by the parse mechanism(s) 122 (FIG. 1A).

The parsing (at 412) produces, as output, data from the recipe 300, as follows: From the source data (the recipe 300) in schema.org recipe structure, materialized in JSON-LD form, three types of fields are extracted:
(1) Ingredient Lines which comprise an ordered list of text strings sent (at A1) to an Ingredient Extraction Pipeline (including ingredient NER mechanism 184, at 422, and reference entity resolution 190, at 432).
(2) Steps which is an ordered list of text strings sent (at B2) to a Step Extraction Pipeline (Step NER mechanism 186, at 424, Step Relation Recognition 194, at 444)
(3) Other data (such as, e.g., title, description, and cooking time), which is passed forward (at C3) to the recipe assembly 452 without transformation.

The ingredients (1) and steps (2) may require normalization as there is heterogeneity in the source format online, even within the schema.org constraints.

Output from the parsing is provided to the ingredient named entity recognition (NER) mechanism 184 (at A1), to step NER mechanism 186 (at B2), and to the recipe assembly mechanism 196 (at C3).

From the input recipe 400 (i.e., from the output of the parse), at 422, the ingredient NER mechanism 184 determines ingredients, preparation, quantities, and units. The ingredient NER mechanism 184 may use Bidirectional Encoder Representations from Transformers (BERT) in its determinations. The output of the ingredient NER mechanism 184 is provided (at D4) to reference entity resolution mechanism 188, which determines (at 432) the ingredients, preparation, quantities, and units from a knowledge graph.

The Step NER mechanism 186, using, e.g., BERT, determines (at 424) ingredients, capabilities, settings, and appliances from the parsed input recipe (i.e., from the output of the parsing process 412). Output of the step NER mechanism 186 is provided (at E5) to reference entity resolution mechanism 190, which determines (at 434) ingredients, capabilities, settings, and appliances from the knowledge graph.

Output from the step NER mechanism 186 is also provided (at F6) to the step relation recognition mechanism 194. When the Recipe Understanding system finds settings such as times or temperatures, it may not be apparent to which, if any, capability event these belong. For example: “Bake for 20 minutes and let cool for 5 minutes”. In this sentence, the system needs to relate the first time (20 minutes) with the capability “Bake” and also needs to know that the second time (5 minutes) is not a time setting for an appliance. The Step Relation Recognition process 444 evaluates all candidate pairs of related entities and determines whether they are related and the type of relation. In this example, the “bake” capability “cckg:hasTimeSetting” “20 minutes”. The understanding of “bake” and “20 minutes” comes in Reference Entity Resolution (434).

Output from the step relation recognition mechanism 194 is provided (at L12) to the recipe assembly mechanism 196.

Outputs from the reference entity resolution mechanisms 188 and 190 are provided (at H8 and I9) to step ingredient relation mechanism 192. The outputs from the reference entity resolution process 432 and reference entity resolution process 434 map ingredients found in unstructured text to the same ingredient space. A suite of similarity functions using the output of the NER and constraints are used to determine which ingredients found in steps are which ingredients from the ingredient list. This is necessary so that the user can weigh in situ, and the digital experience can prompt the user with ingredients and preparations, and quantities as relevant in the guided cooking experience. In some cases, ingredients may be split between steps, for example, where a single ingredient is used for multiple purposes or is added in stages.

Output from the step ingredient relation mechanism 192 is provided (at K11) to the recipe assembly mechanism 196.

Output from the reference entity resolution mechanism 190 is provided (at J10) to the recipe assembly mechanism 196.

The recipe assembly mechanism 196, at 452, generates the connected recipe 460, using some or all of the inputs received from:
the parsing process 412 (at C3)
the reference entity resolution process 432 (at G7)
the step ingredient relation process 442 (at K11),
the reference entity resolution process 434 (at J10), and
the step relation recognition process 444 (at L12).

The ML framework 116 is a mechanism or collection of mechanisms (an application 112, FIG. 1A) and may operate on one or more computer systems, e.g., as described below.

The ML framework 116 uses a curated knowledge graph of culinary processes, ingredients, and measurement units. Appliance capabilities are mapped to the knowledge graph, and the machine learning framework 116 is trained to annotate recipes via the knowledge graph.

A connected recipe 460 produced ML framework 116 may include ingredient lists, step descriptions, and step metadata (e.g., ingredients and appliance data) required for guided cooking. The connected recipe 460 may be used to present a guided cooking flow, e.g., within an application (app) on a user's computing device and/or on a connected appliance, as discussed below.

Extracting Key Entities from Source Recipes

In this solution, the system needs not only to detect the target entities but also to relate them to each other and resolve them to a canonical knowledge base. Note that in these cases, the system is not relying on appliance instruction directly. Instead, the goal is to transform the recipe into a standard form that a variety of connected appliances can cook. These appliances are configured on the platform as being able to fulfill a set of standard capabilities and settings, specifying how these universal concepts map to local appliance capabilities and settings. This solution thus bridges the semantic gap between the culinary domain and the conventions in the connected appliance domain.

Key Entities in Ingredient Lines

| | | Example | |
|---|---|---|---|
| Entity | Description | Source | Example Ref. |
| Ingredient | A canonical ingredient | “salt” | cckg:Salt |
| | | “thyme” | cckg:FreshThyme |
| Quantity | A numeric amount | “¾” | 0.75 |
| Unit | The unit associated | “clove” | cckg:Clove |
| | with the ingredient | | |
| | quantity. | | |
| | | “tsp” | cckg:USTeaspoon |
| Preparation | A list of ordered | “minced” | cckg:Minced |
| | canonical Preparations | | |
| | to be applied to the | | |
| | Ingredient before the | | |
| | main procedure. | | |

For example, the source Recipe Ingredient text string “2 cloves garlic (minced)” when processed may become:

```
source_text: 2 cloves garlic minced
reference_ngredient_id: cckg:Garlic
quantity:
  amount: 1
  reference_unit_id: cckg:Clove
reference_preparations_ids:
  cckg:Minced
```

Similarly, “3 tbsp olive oil” may become:

```
source_text: 3 tbsp olive oil
reference_ingredient_id: cckg:OliveOil
quantity:
  amount: 3
  reference_unit_id: cckg:USTablespoon
```

Once the canonical ingredient is known, the system can also know the unit density and scaling exponent. This means the recipe ingredient can easily be scaled or converted to a different unit system dynamically in line with the preference of the home cook.

### Key Entities in Instruction Steps

In a step, the system may extract the following entities:

| Entity | Description | Example Source | Example Reference |
|---|---|---|---|
| Ingredient | An ingredient from the | “salt” | cckg:Salt |
| | Ingredient list | | |
| Capability | A cooking technique that | “roast” | cckg:Roast |
| | kitchen appliance can | | |
| | fulfill. | | |
| Setting | A Setting Value; can be of | “400 degrees | cckg:TemperatureSetting 400 |
| | type Pressure, Speed, | Fahrenheit” | cckg:Fahrenheit |
| | Temperature, Time, | | |
| | Venting, Power | | |

Note the entity Capability might be considered a CapabilityEvent, i.e., a point in the recipe has been reached where there is a culinary event that an appliance can fulfill. This may use known methods for event detection in text, where the system tries to find an event trigger to localize the event in the text and then search the text neighborhood for related entities.

So, for example, “Preheat the oven to 400 degrees Fahrenheit (205 degrees Celsius)” becomes:

```
source_text: Preheat the oven to 400 degrees Fahrenheit (205
degrees Celsius)
text: Preheat the oven to 400 degrees Fahrenheit (205 degrees Celsius)
capability:
  reference_capability_id: cckg:PreheatRoast
  Settings:
    reference_setting_id: cckg:TemperatureSetting
    value:
      type: number
      value: 400
      reference_unit_id: cckg:Fahrenheit
```

In practice, both temperatures from the source text are stored as preferred conversion amounts. As with Ingredient quantity units, the reference to standard settings and units enables easy conversion for different appliance and user contexts.

This example needs two connected steps: “Roast the fennel in the oven for 25 minutes. After 25 minutes, if using parmesan, sprinkle it over the fennel and then return the tray to the oven to bake for another 10 minutes.”

```
  source_text: “Roast the fennel in the oven for 25 minutes.”
  text: “Roast the fennel in the oven for 25 minutes.”
  reference_capability_id: cckg:Roast
  Settings:
    reference_setting_id: cckg:TimeSetting
    value:
      type: number
      value: 1500
      reference_unit_id: cckg:Second
    ingredients:
    Ingredient_idx: 1
    quantity:
      amount: 2
source_text: “After 25 minutes, if using parmesan, sprinkle it over the
fennel and then return the tray to the oven to bake for another 10 minutes.”
text: “After 25 minutes, if using parmesan, sprinkle it over the fennel and
then return the tray to the oven to bake for another 10 minutes.”
  reference_capability_id: cckg:Roast
  Settings:
    reference_setting_id: cckg:TimeSetting
    value:
      type: number
      value: 600
      reference_unit_id: cckg:Second
    ingredients:
    ingredient_idx: 7
    quantity:
      amount: 0.25
      reference_unit_id:
        cckg:USCup
```

Note that the ingredients needed in the steps point to their position in the original Recipe Ingredients List.

### The Ingredients Extraction Pipeline

The process for extracting structured entities from an Ingredient Line is as follows:
1. Recognize entity text spans using a Named Entity Recognition model (e.g., Ingredient NER 184, FIG. 1C, implemented at 422, FIG. 4B). This machine learning model may also classify the type of entity as one of: Ingredient, Preparation, Quantity, or Unit.
2. Resolve Ingredients to Knowledge Base of Ingredients using similarity techniques such as distance measures and vector similarity (e.g., Step ingredient relation 192, FIG. 1C, implemented at 442, FIG. 4B).
3. Resolve Preparations to Knowledge Base of Preparations using the same methods.
4. Resolve Quantity to literal amount using various text parsing techniques.
5. Resolve Units to Canonical units using a lookup function; these follow a standard convention in nearly all cases.

Due to the convention at the source, the system can associate the entities in a line together with implicit relationships. The system can then construct a target Recipe Ingredient data object.

In some implementations (embodiments), this processing may be extended, e.g., to record recommended unit conversions, ingredient substitutions, dietary direction, and/or alternative preparation methods. Some of these are described in the Smart Kitchen algorithms below.

### The Step Extraction Pipeline

In exemplary embodiments, the process for extracting structured entities from a Recipe Step is as follows:
1. Identify and classify spans of entity references in each step for entity classes: Capability, TemperatureSetting, TimeSetting, PressureSetting, PowerSetting, SpeedSetting, VentingSetting, Ingredient
2. Identify the relationship between capability events and settings. Each setting must be related to at most one capability.
3. Identify new step boundaries. To support a smooth guided cooking experience, the system preferably guarantees no more than one capability event per target recipe step. In some cases, this may require injecting new step boundaries. In others, this may require conjoining steps.
4. Resolve Ingredients to Knowledge Base
5. Match ingredients to ingredients found in the ingredients list with any optional quantities present—note this depends on the Ingredient Extraction Pipeline.

Examples of the low-level inputs and output for the primary machine learning models for Step Extraction are included in Appendix B hereto.

### Recipe Assembly

Information from the source recipe, the Ingredient Extraction Pipeline, and the Step Extraction Pipeline are combined in a final recipe format (an example of which is shown in Appendix C hereto). Further semantic tags are added explicitly and implicitly for use in search, recommendation, and other indexing applications.

This recipe can then be prepared (e.g., by a home cook who has (an) appliance(s) that can fulfill the capabilities required by the recipe). This “capability fulfillment” is completed just in time so the home cook can choose which appliance(s) they would like to use.

### Training

Training a machine learning pipeline involves supervised learning, where output data is corrected, and thus the algorithm may learn to improve.

As noted above, various ML components of the ML framework 116 (the Ingredient NER mechanism(s) 184, Step NER mechanism(s) 186, reference entity resolution mechanism(s) 188, reference entity resolution mechanism(s) 190, Step ingredient relation mechanism(s) 192, and Step relation recognition mechanism(s) 194) are machine learning (ML) models, trained to perform their respective functions.

The ML components may be trained using training mechanism(s) 118, training data 144, and knowledge graph(s) 148. The training data 144 may include already structured recipes (e.g., JSON-LD). The training mechanism(s) 118 may be supervised.

Where the extracted data are sufficiently accurate to be used in a real-world context, a huge amount of training and adjustment is required. This may be addressed in a few ways:

The model has several distinct parts: rather than comprising a large “black box” that is trained to understand the recipe fully. Breaking the model into parts allows a) the function of each part to be refined and b) each model to be trained and evaluated according to its criteria.

Training the models is aligned with the general data entry of recipes. While the model is being trained, its best effort is considered a worthwhile starting point for recipe input, while the data entry required to finalize the recipe may also be used to train the models through output verification and correction.

### Smart Kitchen Algorithms

Embodiments and implementations hereof may be used to implement so-called smart kitchen algorithms. Such smart kitchen algorithms allow the platform to apply culinary expertise automatically to adapt a recipe to achieve desired results.

An implementation of the recipe framework 102 may include some or all of the following smart kitchen algorithms:
Calibration
Recipe scaling
Ingredient substitutions
Nutritional information determination
Recommendations
Capability resolution

Details of these algorithms are discussed in greater detail here.

### Calibration

Calibration of appliances, ingredients, and recipes allows for establishing a mapping between the original version of a recipe, the canonical form based on standardized capabilities and ingredients, and the best or optimal settings to be used in a specific context to achieve the best results.

Ingredients may be calibrated in the lab, either manually or automatically.

Manufacturers may be given a set of tests to ensure that an appliance's performance may be compared with the standard and understood.

Connected appliances may incorporate calibrated sensors allowing performance to be monitored at runtime.

Usage data may be mined to learn optimal settings and timings for recipes and to calibrate the differences between ingredients and appliances based on user behavior.

The machine learning pipeline may be trained to infer a calibration for a recipe based on context (for example, performance of appliances, known local tastes, or the composition of ingredients in a particular culture or region).

Calibration may be implemented by calibration mechanism(s) 170 (FIG. 1B) and may use calibration data 337.

### Recipe Scaling

Recipe scaling is a feature that allows the quantity of food provided by a recipe to be adjusted.

In its simplest form, recipe scaling involves adjusting the quantity of ingredients in a fixed ratio. Scaling by portion allows the recipe to be adjusted to feed a given number of people. Scaling based on an ingredient amount allows the chef to adapt a recipe limited by the amount of one or more ingredients. Scaling recipes may allow some ingredients to scale non-linearly. For example, in baking, the quantity of raising agent required scales proportionally to the surface area of a baking container, not the volume of ingredients. This may also be approximated using a logarithmic scaling factor.

Raising agents used in recipes may also be scaled to take into account air pressure changes caused by altitude.

Scaling for container size allows a chef to prepare a recipe based on available containers, allowing for rising.

Adjusting cooking time for a scaled recipe. This can take into account the physical form of the food, for example:
A roast of meat will take time proportional to the cube root of the volume/mass
A cake will take time proportional to the shortest dimension of the container
Muffins in tins should not take longer if more tins are used

Recipe scaling may be implemented by recipe scaling mechanism(s) 172 (FIG. 1B).

### Ingredient Substitutions

Ingredient substitutions may offer guidance where the original ingredient is unavailable or does not meet the user's food preference. Ingredient substitutions may require scaling of the substitute.

Ingredient substitution may include simple substitutions, full substitutions, or full recipe substitutions.

In a simple substitution, one ingredient is substituted for another (e.g., blueberries for raspberries) with a scaling factor.

With full substitutions, one ingredient may be replaced by more than one other ingredient. With full substitutions, context and purpose may be required (e.g., 1 tablespoon of tapioca starch blended with 3 teaspoons of water as a vegan substitute for one egg used as a binder/thickener). The ingredient context/purpose may be explicitly tagged in recipe metadata in the connected recipe. It may also be output from the machine learning pipeline.

Full recipe conversions (e.g., to vegan, gluten-free, kosher versions of a recipe) may filter tags (e.g., vegan or gluten-free, or kosher) in candidate ingredient substitutions to infer alternative versions of the recipe. Full recipe conversions may also be the subject of machine learning.

Full recipe conversions may use simple or full substitutions to substitute some ingredients.

Ingredient substitutions may be implemented by ingredient substitution mechanism(s) 174 (FIG. 1B).

### Nutritional Information Determination

Nutritional information may be collated for a known, converted, scaled, or substituted recipe in one or more of the following ways:
By adding the nutrients contained in the ingredients.
By applying heuristic knowledge about the effect of cooking on nutrients.
Through machine learning, the nutritional content is measured after cooking and used to train the model.

Nutritional information determination may be implemented by nutritional information mechanism(s) 176 (FIG. 1B).

### Recommendations

In some cases, the recipe framework 102 may recommend recipes based on a user's preferences, history, or context. Recommendations may be made:
By filtering recipe tags based on the user's requirements (e.g., gluten-free)
By filtering recipes that are compatible with the user's appliances
By applying machine learning to the body of usage data and comparing it with the user's recipe (making/browsing) history
By discovering recipes based on the ingredients available to the user
   Based on a list of ingredients nominated by the user at runtime
   Based on the user's shopping history, within the app, or via an ingredient shopping API
   Using machine vision (with a camera based in the user's refrigerator)
   To minimize food waste (preferentially using ingredients with a closer use-by date)
By evaluating options with additional ingredients:
   Including readily available ingredients
   Incorporating ingredients locally available from a food waste API
   To incorporate seasonal ingredients
   To minimize delivery distances with locally produced ingredients

Recommendations may be implemented by Recommendations mechanism(s) 178 (FIG. 1B).

### Capability Resolution

Capability resolution is the process of matching appliances to the requirements of a recipe. As well as resolving the appliance to be used in a recipe where the original appliance is not available, capability resolution can answer questions such as: “Can recipe X be created with the appliances available to user Y?” “Which is the best match from user Y's appliances to create recipe X?”, “Which recipes from search result Z are appropriate to display to user Y based on their appliances?”.

Capability resolution may rely on various algorithms to answer these questions, e.g.:
A simple match between the capability knowledge graph ensures basic compatibility
Learning the usage of the appliance via statistical analysis of cooking events recorded on the platform
Machine learning, using the corpus of recipes understood by the system to understand how the appliance appears in recipe contexts

Capability resolution may be implemented by Capability resolution mechanism(s) 180 (FIG. 1B).

### Usage and Use Cases

Exemplary non-limiting uses and use cases of system 100 are described here. Those of skill in the art will understand, upon reading this description, that different and/or other uses and use cases are possible and are contemplated here.

### Generating Connected Recipes

The recipe framework 102 may be used to create libraries of connected recipes from existing recipes. For example, a library of appliance-specific connected recipes may be generated from existing recipes. A manufacturer may then provide these appliance-specific connected recipes with their appliances.

A user 104 may use the recipe framework 102 to create or adapt existing recipes to form a personal library of connected recipes based on the user's preferences and appliances. The user may adapt connected recipes in their library to deal with nutritional issues (e.g., allergies, dietary preferences, or requirements). The user may scale connected recipes in their library to provide more portions when needed.

Implementations are useful, e.g., for transforming a body of recipes developed by a manufacturer (onboarding/migration) and for transforming human-readable recipes. Recipes may be published in a specific context, shared between users (e.g., via email, instant chat, a social networking platform, or the like), or discovered by a user searching the web—either within a dedicated application or by copying a link discovered using a web browser or other browsing tool (e.g., by clipping). The machine-learning framework is invoked, allowing the recipe to be ingested by the platform and subsequently presented in various ways.

In presently preferred implementations, the output from the machine learning pipeline is a JSON-LD description of the recipe with annotated guided cooking metadata which may then be used to present a guided cooking flow within the user's app. JSON-LD is a standard way of describing recipes that allows these recipes to be shared, indexed, appear in google search results, etc.

The approach described is amenable to presenting recipes in an app or other contexts, for example, on the user interface of an appliance equipped with a screen (e.g., a color touchscreen), with an SDK embedded in another app, on the display of a touchscreen-enabled appliance, as a so-called widget layer presented upon the original recipe, or via a home voice assistant.

Another aspect is a user interface with a separate so-called widget layer upon a recipe that allows connected ingredient and appliance features to appear. This supports usability and provides a way to clearly show that the original recipe has not been altered, nor is any ownership of the recipe being claimed.

### Using Connected Recipes

A connected recipe (either acquired from a library or generated) may be used by a user 104 in conjunction with the recipe framework 102.

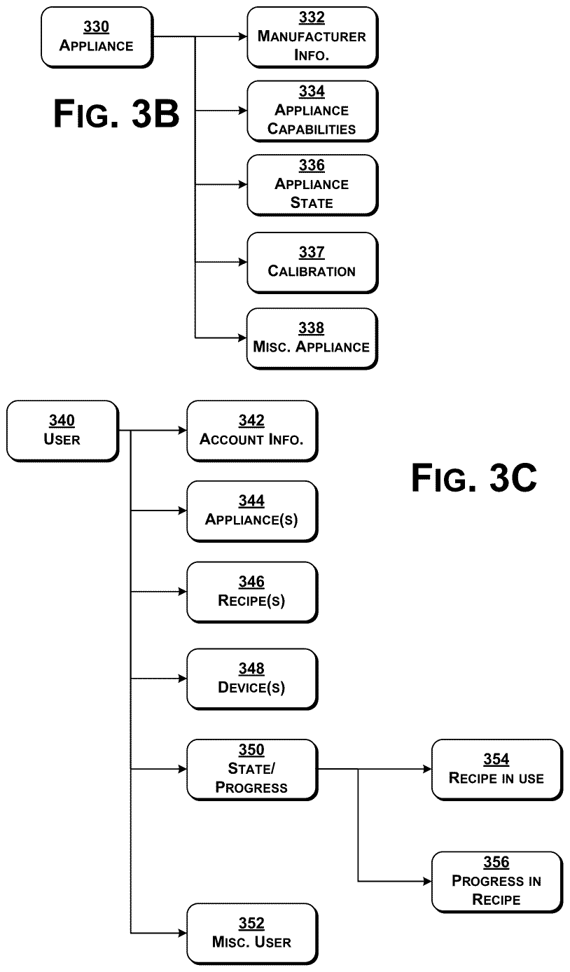

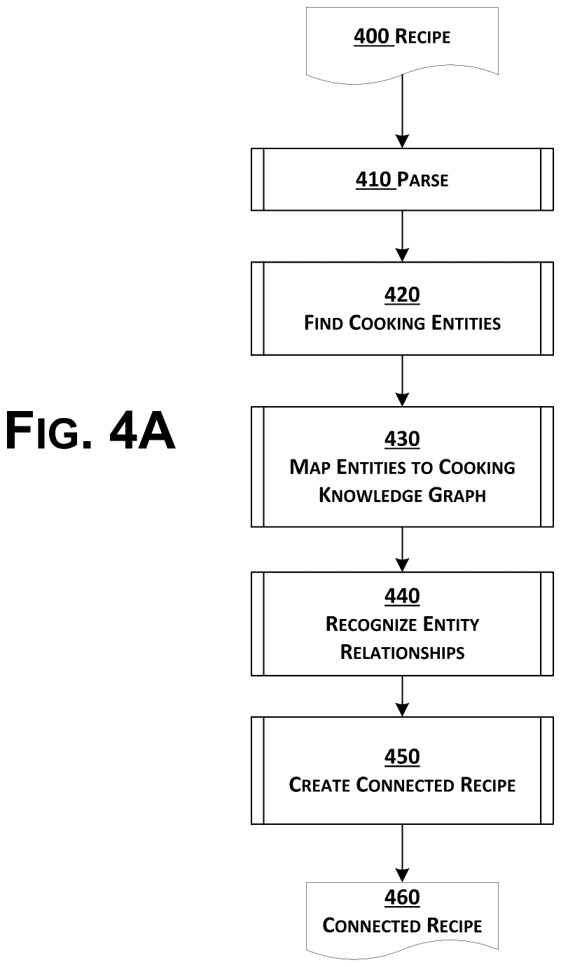

An example of a user using a connected recipe is described here with reference to FIG. 5A (a simplified version of FIG. 1A, omitting most of the recipe generation mechanisms). In this example, the user 104 has k devices 108-1, 108-2 . . . 108-k (individually and collectively devices 108) and m appliances 110-1, 110-2 . . . 110-m (individually and collectively appliances 110).

For this example, assume that the user has obtained a connected recipe (e.g., from their library).

Depending on which device or appliance the user uses, the recipe (the steps, ingredients, progress, etc.) may be presented differently. For example, if a device 108-i is a tablet (e.g., an Apple iPad or the like), a recipe program 214 having a recipe user interface 216 (FIG. 2A) may be used to present the recipe to the user on the device's display 206. The user may interact with the recipe program 214 via the user interface 216, using, e.g., the interaction mechanism(s) 208. Similarly, if the user is viewing/using the recipe on an appliance 110-p, then (with reference again to FIG. 2B), the appliance's recipe programs 244 may use the appliance's recipe user interface 246 to present aspects of the recipe on the appliance's display(s) 236. The user may interact with the recipe program 244 on the appliance via the user interface 246, using, e.g., the appliance's interaction mechanism(s) 238.

Recall, as described above (with reference to FIG. 3A), a connected recipe comprises a list of ingredients 318 and a list of steps 316. Some steps require input (of one or more ingredients from the list of ingredients or the output of a previous step). Some steps may require the use of an appliance. Some steps may depend on the completion of other steps.

As the user progresses through a recipe, the user may switch between user devices 108 and appliances 110. As should be appreciated, to maintain consistency across devices and appliances, a true version of the recipe's progress and state is required. Accordingly, the recipe framework 102 (e.g., using synchronization mechanism 130) maintains the current and true state of the recipe's progress, e.g., as state/progress 350 in the user data 340 (FIG. 3C) in the user database 146. The synchronization mechanism 130 may obtain state data from the user's devices 108 and appliances 110. When a device or appliance comes online or is being used, it interfaces with the synchronization mechanism 130 to get the true state of the recipe's progress. The state/progress of the recipe maintained by the recipe framework 102 is considered “true” in that, in the event of any discrepancy between different versions of the state/progress of the recipe, the state/progress maintained by the recipe framework 102 will govern.

A user may switch devices while using a recipe, with each device being in the correct place (at the correct stage or step) of the recipe. For example, a user may search for a recipe on their cell phone (a device 108) while away from home, using a recipe program 214 (e.g., an app) on their phone and interacting with the search mechanism 128 on the recipe framework 102. The search mechanism 128 may search the recipes database 140, from which the user may select a particular connected recipe. In the user database 146, for that user, the selected recipe will be stored as the recipe in use 354, and the state/progress data 350 will record the current progress in the recipe 356.

The recipe user interface 216 on the user's phone may present information about that particular recipe, including the ingredient list. The user may acquire needed ingredients and then go home. At home, the user may switch from their phone to a tablet device (e.g., an Apple iPad). The tablet device also runs a version of the recipe program 214 and uses the state/progress data 350 stored in the user database 146 for that user. That recipe will position the user at the correct location in the recipe.

The user may use a particular connected appliance 110 to perform some recipe steps (e.g., boil water or roast a chicken). The particular connected appliance 110 may connect directly with the recipe framework 102 to obtain the current state of the recipe (so that a display on the appliance can present current recipe information to the user). The appliance may also communicate its state (e.g., oven temperature, etc.) back to the recipe framework 102. The recipe framework 102 may update the recipe's status based on information communicated from the device.

As the user progresses through the recipe, each device and appliance used with the recipe framework 102 will maintain synchronization with the recipe's state as stored in the recipe framework 102.

If a particular user device 104 does not have or support a recipe program, e.g., if the device is a general-purpose computer such as a laptop computer, the user may interact with the recipe framework 102 with an interaction widget running, e.g., on top of a browser. As noted above, this approach is amenable to presenting recipes in an app or other contexts, for example, on the user interface of an appliance equipped with a screen (e.g., a color touchscreen), with an SDK embedded in another app, on the display of a touchscreen-enabled appliance, as a widget layer presented upon the original recipe, or via a home voice assistant. As used herein, an interaction widget refers to code (software) that implements aspects of the recipe interaction that encapsulates functionality of the recipe application. The interaction widget allows the user to access the recipe framework 102 without a specialized application.

FIG. 5B is a flowchart of an exemplary process 500 of using a connected recipe on multiple devices and/or appliances. The process 500 in FIG. 5B operates, e.g., in a system in which a recipe is stored on a recipe framework, and includes, by a user having one or more devices and one or more appliances:

A recipe program presenting recipe information (at 502) to the user using a device interface on a first of the one or more devices and/or on an appliance interface of a first appliance of the one or more appliances. The process also includes (at 504) tracking interactions of the user with the recipe program via the device interface or the appliance interface. The process also includes (at 506) monitoring the progress and state of the recipe. The process also includes (at 508), based on the monitoring, maintaining in the recipe framework, a version of the progress and state of the recipe. The process further includes (at 510), while the recipe is in progress, and in response to the user switching to a second device of the one or more devices and/or to a second appliance of the one or more appliances, presenting recipe information on the second device and/or on the second appliance based on the version of the progress and state of the recipe maintained in the recipe framework, wherein the second device or second appliance obtains the version of the progress and state from the recipe framework.

### Data Collection

The recipe framework 102 may collect and store data relating to user interactions with the framework and recipes. The data may be stored in the history database 150 (FIG. 1A). The stored history data may be used to gain insights about users, appliances, and recipes.

Storing the history of usage of the platform for appliances and users allows valuable insights, for example, on recipe choice, real-world metrics for recipes, and appliance diagnostics.

### Examples

### Source Recipes

Appendix A hereto shows an example of a Schema.org recipe in JSON-LD format.

There is a barrier to making these recipes automatically cookable on smart devices. The fields that contain the information on recipe ingredients are strings in the recipeIngredient property, for example:

```
“recipeIngredient”:[
  “2 large bulbs fennel”,
  “3 tbsp olive oil”,
  “2 cloves garlic (minced)”,
  “3/4 tsp salt”,
  “1 tsp black pepper”,
  “1 tsp thyme”,
  “1/4 cup parmesan ((omit if Dairy Free/Paleo/Vegan))”
]
```

The sequence of steps that the home cook is to follow may also be captured in plain text in the recipeInstructions property, for example:

```
“recipeInstructions”:[
    {
    “@type”:“HowToStep”,
    “text”:“Preheat the oven to 400 degrees Fahrenheit (205 degrees
Celsius)”,
    “name”:“Preheat the oven to 400 degrees Fahrenheit (205 degrees
Celsius)”,
    “url”:“https://www.everylastbite.com/roasted-fennel/#wprm-recipe-
21234-step-0-0”
    },
    {
    “@type”:“HowToStep”,
    “text”:“Remove any of the stalks from the fennel bulbs and then cut
them in half lengthwise. Cut each halved fennel bulb into 1/2 inch thick
slices and arrange the slices on a parchment paper-lined baking sheet,
ensuring that they are all laid out evenly and do not overlap.”,
    “name”:“Remove any of the stalks from the fennel bulbs and then cut
them in half lengthwise. Cut each halved fennel bulb into 1/2 inch thick
slices and arrange the slices on a parchment paper-lined baking sheet,
ensuring that they are all laid out evenly and do not overlap.”,
    “url”:“https://www.everylastbite.com/roasted-fennel/#wprm-recipe-
21234-step-0-1”
    },
    {
    “@type”:“HowToStep”,
    “text”:“In a bowl, combine the olive oil and minced garlic and brush
it over the sliced fennel and then sprinkle the thyme, salt, and pepper over
top to ensure they are all well-seasoned.”,
    “name”:“In a bowl, combine the olive oil and minced garlic and
brush it over the sliced fennel and then sprinkle the thyme, salt, and
pepper over top to ensure they are all well-seasoned.”,
    “url”:“https://www.everylastbite.com/roasted-fennel/#wprm-recipe-
21234-step-0-2”
    },
    {
    “@type”:“HowToStep”,
    “text”:“Roast the fennel in the oven for 25 minutes. After 25 minutes,
if using parmesan, sprinkle it over the fennel and then return the tray to
the oven to bake for another 10 minutes.”,
    “name”:“Roast the fennel in the oven for 25 minutes. After 25
minutes, if using parmesan, sprinkle it over the fennel and then return the
tray to the oven to bake for another 10 minutes.”,
    “url”:“https://www.everylastbite.com/roasted-fennel/#wprm-recipe-
21234-step-0-3”
    },
    {
    “@type”:“HowToStep”,
    “text”:“After 35 minutes of baking, the fennel should be tender and
caramelized on the edges (cook for another 5-8 minutes if it is not yet
tender). Serve warm.”,
    “name”:“After 35 minutes of baking, the fennel should be tender and
caramelized on the edges (cook for another 5-8 minutes if it is not yet
tender). Serve warm.”,
    “url”:“https://www.everylastbite.com/roasted-fennel/#wprm-recipe-
21234-step-0-4”
    }
  ]
```

These sections contain the specific instructions for assembling recipe ingredients and executing the recipe. However, this data is in a semi-structured form; that is, it has sequence and some conventions, but otherwise is unstructured text. To, for example, make ingredients weighable or know what settings or capabilities to use on an appliance, structured data must be extracted from this text.

The target structure data required is defined centrally in the system 100. These data are stored centrally in an ontology and made available in an API that references a graph database, referred to as the Connected Cooking Knowledge Graph (or cckg as the shortened namespace).

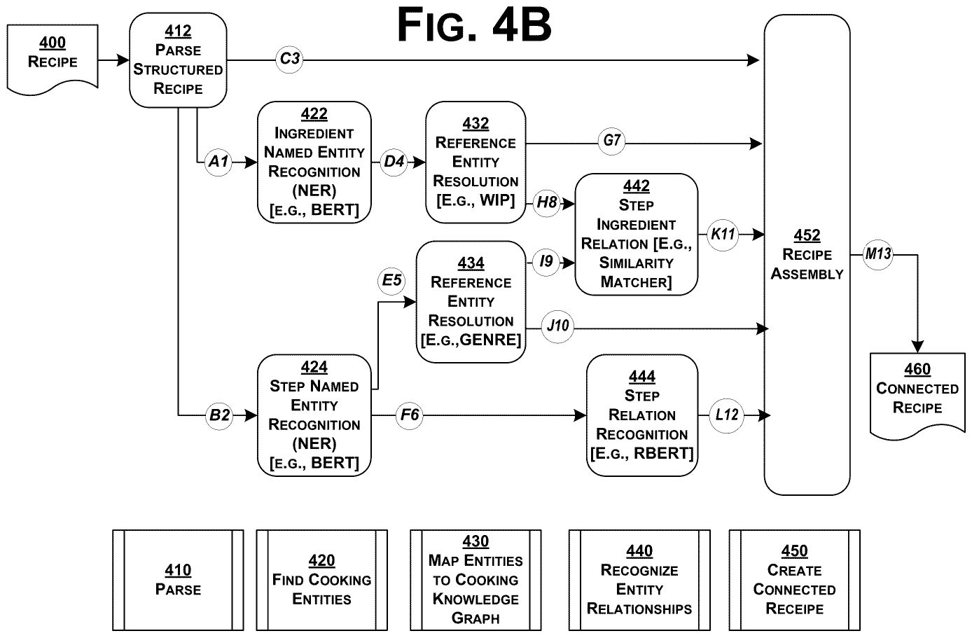

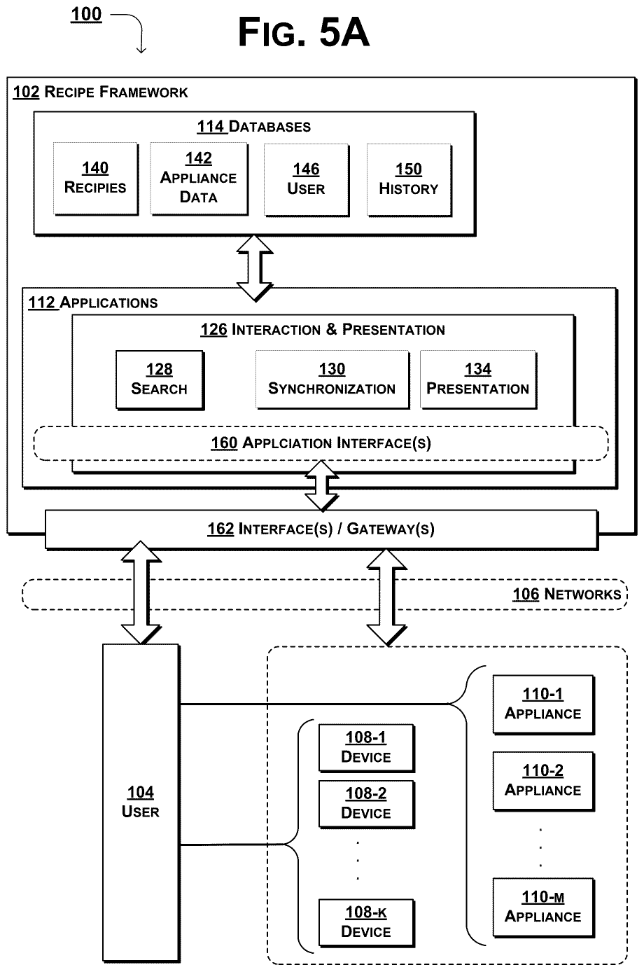

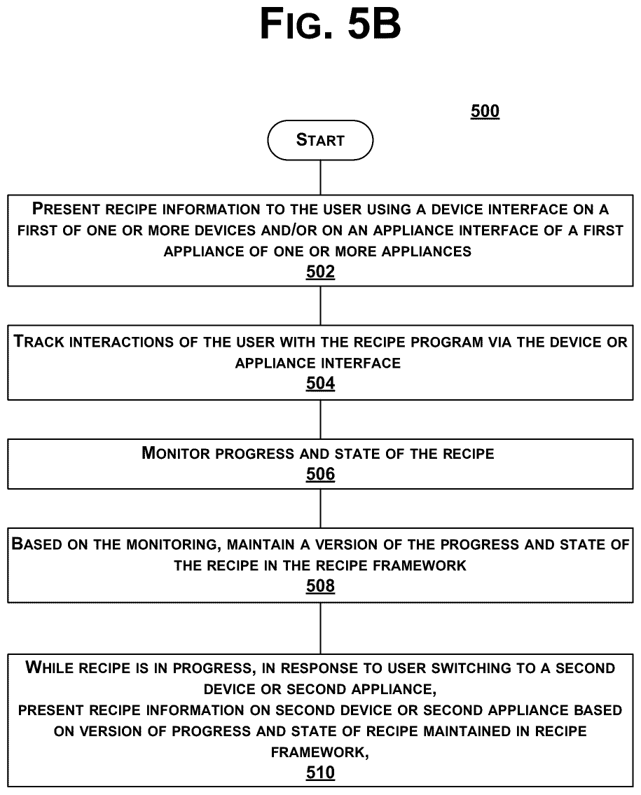

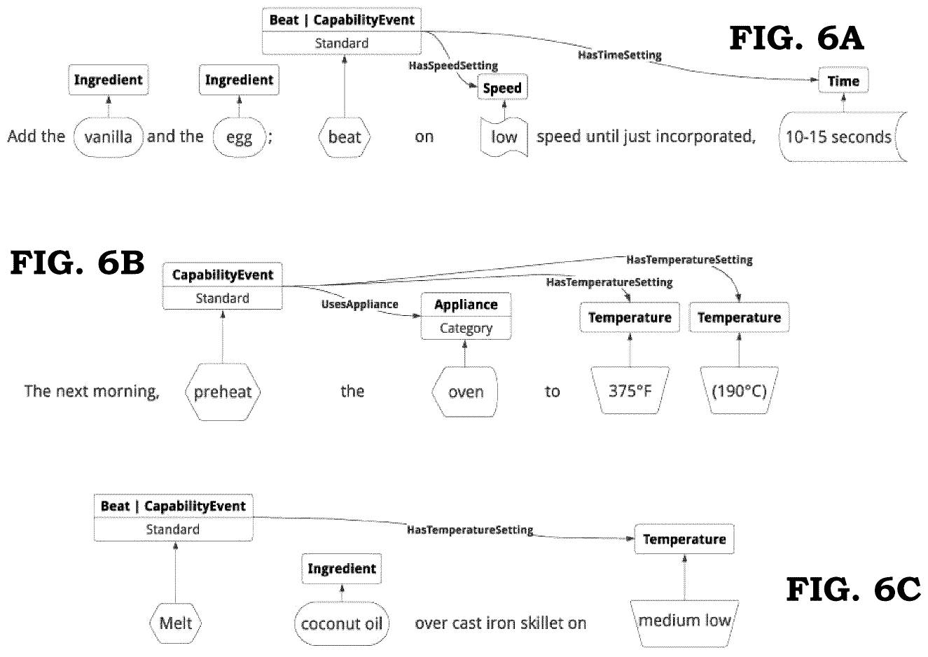

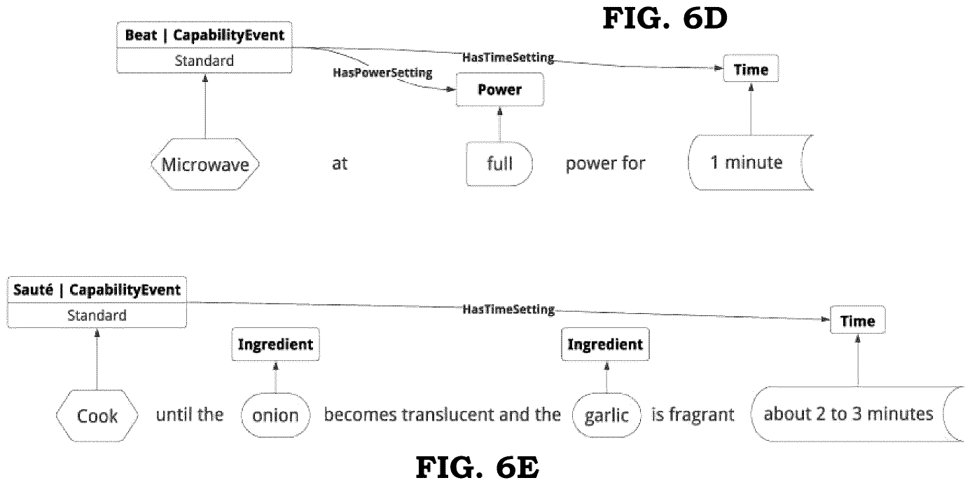

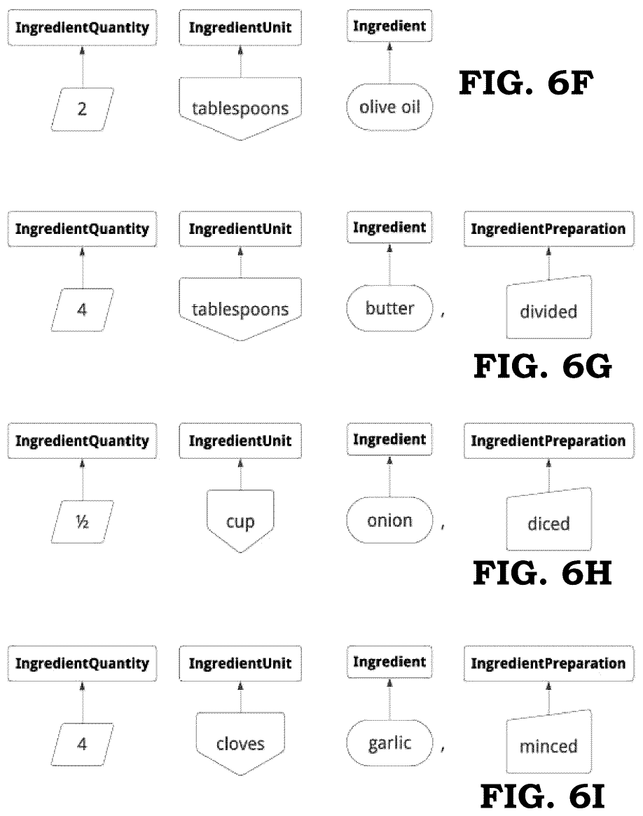

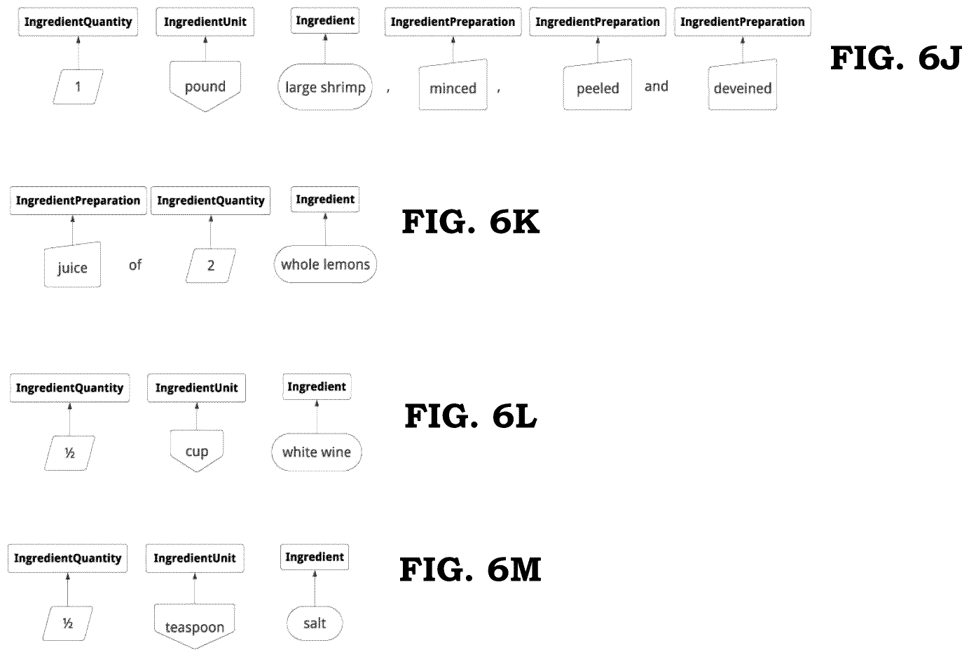

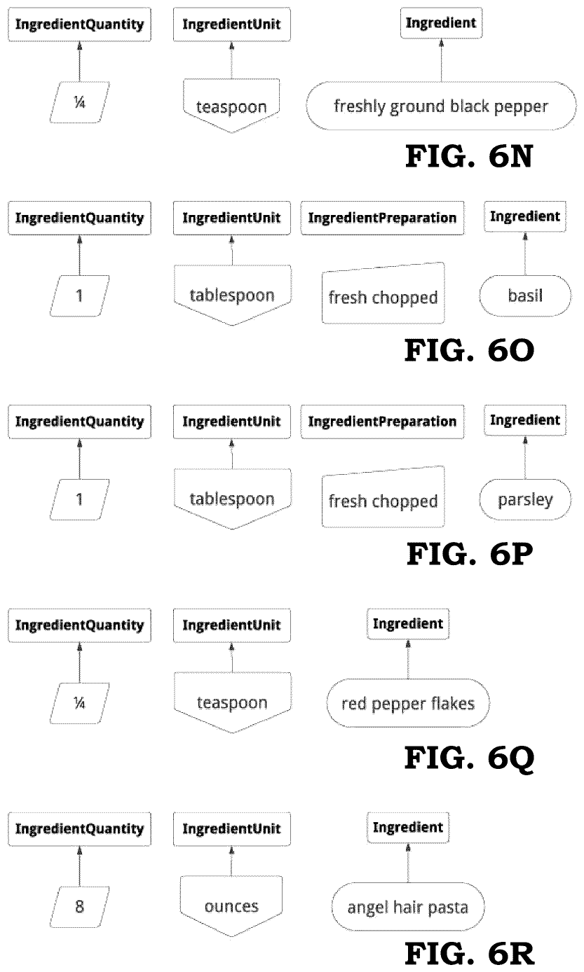

FIGS. 6A-6E show examples of ground truth semantic labels overlaid on plain recipes. Example steps containing Capability events overlaid with semantic information. These semantic structures are the target for the machine learning models and are driven by the reference data.

For example, in FIG. 6A, the plain recipe text is “Add the vanilla and the egg; beat on low speed until just incorporated—10-15 seconds or so.” Semantic information “ingredient” is shown overlaid on “vanilla” and “egg,” semantic information “speed” is overlaid on “low,” and semantic information “time” is overlaid on “10-15 seconds.”

FIGS. 6F-6R show an example of an ingredient section in a recipe, similarly with semantic information overlaid.

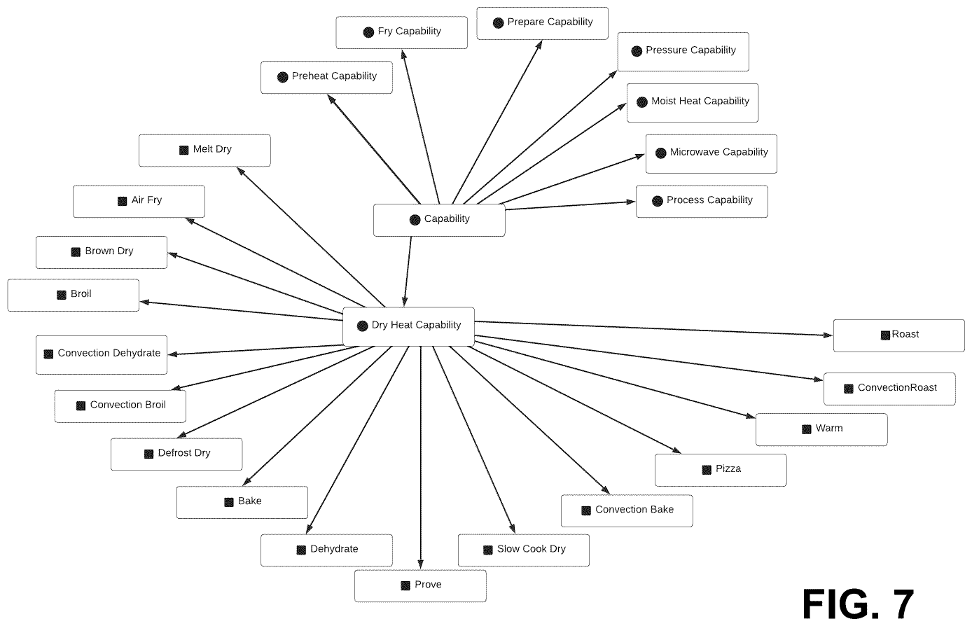

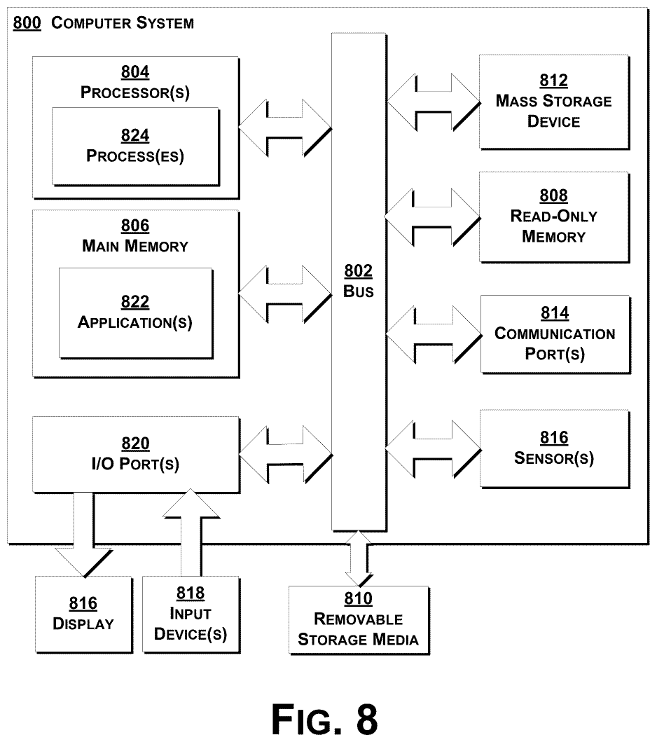

FIG. 7 provides a visualization of standard cooking capabilities according to exemplary embodiments hereof.

Below is a list of method (or process) embodiments. Those will be indicated with the letter “P.” Whenever such embodiments are referred to, this will be done by referring to “P” embodiments.
P1. A method in a system in which a recipe is stored on a recipe framework, the method comprising, by a user having one or more devices and one or more appliances:
a recipe program presenting recipe information to the user using a device interface on a first of said one or more devices and/or on an appliance interface of a first appliance of said one or more appliances;
tracking interactions of the user with the recipe program via the device interface or the appliance interface;
monitoring progress and state of the recipe;
based on said monitoring, maintaining in said recipe framework, a version of the progress and state of the recipe; and
while the recipe is in progress, and in response to the user switching to a second device of said one or more devices and/or to a second appliance of said one or more appliances, presenting recipe information on the second device and/or on the second appliance based on the version of the progress and state of the recipe maintained in the recipe framework, wherein the second device or second appliance obtains the version of the progress and state from the recipe framework.
P2. The method of embodiment P1, wherein the version of the progress and state of the recipe maintained in the recipe framework is a true version of the progress and state of the recipe.
P3. The method of any of embodiment(s) P1-P2, wherein, if there is a discrepancy between versions of the progress and state of the recipe, the progress and state maintained by the recipe framework will govern.
P4. The method of any of embodiment(s) P2-P3, wherein the recipe framework is accessible via one or more interfaces, and wherein a device or appliance obtains the true version of the progress and state from the recipe framework via said one or more interfaces.
P5. The method of any of embodiment(s) P2-P4, wherein the recipe framework, wherein the true version of the progress and state of the recipe is based on received streams of events and/or state data coming from the one or more devices and/or the one or more appliances.
P6. The method of any of embodiment(s) P5, wherein state data from an appliance includes information about a current state of the appliance.
P7. The method of any of embodiment(s) P1-P6, wherein the recipe comprises a list of one or more ingredients and a list of recipe steps, and wherein the state of the progress and state of the recipe comprises information about which recipe step or steps have been completed.
P8. The method of any of embodiment(s) P1-P7, wherein the recipe framework determines which one or more appliances to use for the recipe based on information about appliances available to the user.
P9. The method of any of embodiment(s) P1-P8, wherein a determination of which appliances to use for the recipe is made when the user selects the recipe, and using user data maintained by the recipe framework, the user data including appliance data.
P10. The method of any of embodiment(s) P1-P9, further comprising performing one or more of the following acts:
(i) calibration; (ii) recipe scaling; (iii) ingredient substitutions; (iv) nutritional information determination; (v) recommendations; and (vi) capability resolution.
P11. The method of any of embodiment(s) P10, wherein the acts are performed before steps and/or ingredients of the recipe are determined.
P12. The method of any of embodiment(s) P10-P11, wherein the recipe determines which of the one or more appliances are to be used, and wherein a determination of which of the one or more appliances are to be used is made after the acts are performed.
P13. The method of any of embodiment(s) P1-P12, wherein the one or more devices are selected from:
a personal computer, a cell phone, a tablet computer, a desktop computer, a TV, a smartwatch, a voice assistant, or the kitchen appliance interface; and
wherein the one or more appliances are selected from: cooking and food preparation appliances.
P14. The method of any of embodiment(s) P1-P13, wherein the recipe was generated by one or more machine-learning algorithms.
P15. The method of any of embodiment(s) P1-P14, wherein the recipe is a connected recipe that was generated based on an initial recipe.
P16. The method of any of embodiment(s) P15, wherein the initial recipe was a structured recipe, including initial recipe step data, and/or initial recipe ingredient data, and/or initial recipe appliance data.
P17. The method of any of embodiment(s) P15-P16, wherein the connected recipe is a structured recipe and includes:
connected recipe step data and/or connected recipe ingredient data, and/or connected recipe appliance data.
P18. The method of any of embodiment(s) P15-P17, wherein the connected recipe also includes miscellaneous connected recipe data, including connected recipe metadata.
P19. The method of any of embodiment(s) P17-P18, wherein the connected recipe step data and/or connected recipe ingredient data was determined by the one or more machine-learning algorithms based on the initial recipe step data, and/or initial recipe ingredient data, and using a knowledge graph of culinary processes, ingredients, and measurement units.
P20. The method of any of embodiment(s) P14-P19, wherein the one or more machine-learning algorithms comprise a machine learning (ML) pipeline.
P21. The method of any of embodiment(s) P20, wherein the ML pipeline generates said connected recipe step data and/or said connected recipe ingredient data, and/or said connected recipe appliance data.
P22. The method of any of embodiment(s) P20-P21, wherein said ML pipeline includes a first model that recognizes culinary techniques and maps them to a knowledge graph of capabilities that an appliance can fulfill to annotate the connected recipe with capability events.
P23. The method of any of embodiment(s) P22, wherein the first model finds appliance-related parameters.
P24. The method of any of embodiment(s) P23, wherein the appliance-related parameters include one or more of temperature, speed, time, and/or power.
P25. The method of any of embodiment(s) P20-24, wherein said ML pipeline further includes a second model for relation classifications to determine which parameters relate to which capabilities.
P26. The method of any of embodiment(s) P20-P25, wherein said ML pipeline further includes a third model that maps ambiguous capabilities to the knowledge graph of capabilities.

Below is a list of computer-readable medium embodiments. Those will be indicated with the letter “C.” Whenever such embodiments are referred to, this will be done by referring to “C” embodiments.
C27. A computer-readable medium with one or more computer programs stored therein that, when executed by one or more processors of a device, cause the one or more processors to perform the operations of the method of any one of embodiments P1-P26.
C28. The computer-readable medium of embodiment C27, wherein the medium is non-transitory.

Other embodiments include:
A29. An article of manufacture comprising non-transitory computer-readable media having computer-readable instructions stored thereon, the computer-readable instructions including instructions for implementing a computer-implemented method, said method operable on a device comprising hardware including memory and at least one processor and running a service on said hardware, said method comprising the method of any one of embodiments P1-P26.
D30. A device comprising:
(a) hardware, including memory and at least one processor, and
(b) a service running on said hardware, wherein said service is configured to perform the method of any of embodiments P1-P26.
S31. A system comprising at least one device according to the device embodiment(s) D30.

### DISCUSSION

Machine learning workflows can be used to inform many of these smart algorithms. For example, to use recipe context to suggest appliances that can fulfill detected capability requirements, to extract ingredient substitutions suggested in the recipe, and to make use of included calibration data (e.g., “with a convection oven reduce cooking time by 20 minutes”).

Machine learning also helps with tagging recipes. Understanding that a recipe is gluten-free, kosher, or vegan may be an important factor in recipe discovery and is amenable to understanding via the recipe corpus.

In contrast to an unbounded AI solution with limited practical use, the disclosed machine learning pipeline is trained to extract a bounded and specific set of information designed to fulfill the needs of ingredients management, appliance control, and guided cooking use cases for the connected kitchen.

Machine learning can be trained to achieve a high level of certainty in addressing this specific problem by using a defined knowledge graph and defined boundaries for learning models.

Applying machine learning to adapting arbitrary recipes saves a great degree of time and effort in entering these recipes into a database for use with a connected kitchen platform managing kitchen appliances, addressing a significant problem kitchen appliance manufacturers face.

Training the machine learning model to identify and configure a standard knowledge graph of capabilities that multiple kitchen appliances may fulfill addresses the problem of recipe portability. Where, for example, a recipe calls for the user to steam asparagus using a pan with a steamer on a hob, this capability resolution allows the platform to suggest an oven with steam capabilities or a pressure cooker if this is what the user possesses.

The cloud platform addresses users' needs by offering a single interface to appliances, devices, and recipes from multiple sources.

Compared to the original human-readable recipe, this digital kitchen recipe offers many benefits to the home chef:

The digital recipe may freely be searched, facilitating discovery by a user who wishes to make something new, wishes to find a recipe that suits available ingredients, or has specific dietary requirements.

The digital recipe references an ingredient database, which allows the recipe's nutritional value to be calculated so that a nutritional budget may be followed.

The ingredient database also allows the digital recipe to integrate with grocery services.

The digital recipe may be manipulated to a user's requirements. Re-scaling a recipe may assist in avoiding food waste or adapting a recipe to a new context (a larger target audience).

The digital recipe may directly control appliances, saving the home chef time and effort, especially where multiple appliances from different manufacturers are employed.

Integrating an end-to-end solution with end users, recipe understanding, and appliance control creates a learning platform where usage data can help understand recipes, appliances, and user preferences.

Rather than being locked into the experience of a single brand, users are free to choose kitchen products that best meet their needs and interact with multiple appliances and interfaces in a seamless experience.

Training the machine learning pipeline may involve supervised learning, where output data is corrected, and thus the algorithm may learn to improve. Where the extracted data is to be sufficiently accurate to be used in a real-world context, a huge amount of training and adjustment may be required. This is addressed in a number of ways, including:
The model has several distinct parts rather than comprising a single “black box” that is trained to understand the recipe fully. Breaking the model into parts allows (a) the function of each part to be refined and (b) each model to be trained and evaluated according to its criteria.
Training the models is aligned with the general data entry of recipes. While the model is being trained, its best effort may be an acceptable starting point for recipe input, while the data entry required to finalize the recipe may also be used to train the models.
The eventual outcome is the ability to understand nearly any recipe.

### Computing

The applications, services, mechanisms, operations, and acts shown and described above are implemented, at least in part, by software running on one or more computers.

Programs that implement such methods (as well as other types of data) may be stored and transmitted using a variety of media (e.g., computer-readable media) in several manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general-purpose computers, special-purpose computers, and computing devices. One or more such computers or computing devices may be referred to as a computer system.

FIG. 8 is a schematic diagram of a computer system 800 upon which embodiments of the present disclosure may be implemented and carried out.

According to the present example, the computer system 800 includes a bus 802 (i.e., interconnect), one or more processors 804, a main memory 806, read-only memory 808, removable storage media 810, mass storage 812, and one or more communications ports 814. Communication port(s) 814 may be connected to one or more networks (not shown) by way of which the computer system 800 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input and output devices that are appropriate to perform the process.

Processor(s) 804 can be any known processor(s) (e.g., including, without limitation, processors and microcontrollers based on the ARM, Risc-V, and Xtensa architectures). Communications port(s) 814 can be any of an Ethernet port, a Gigabit port using copper or fiber, a USB port, and the like. Communications port(s) 814 may be chosen depending on a network such as a Local Area Network (LAN), a Wide Area Network (WAN), a low-rate wireless personal area network (LR-WPAN), or any network to which the computer system 800 connects. The computer system 800 may be in communication with peripheral devices (e.g., display screen 816, input device(s) 818) via Input/Output (I/O) port 820.

Main memory 806 can be Random Access Memory (RAM) or any other dynamic storage device(s) commonly known in the art. Read-only memory (ROM) 808 can be any static storage device(s), such as Programmable Read-Only Memory (PROM) chips for storing static information, such as instructions for processor(s) 804. Mass storage 812 can be used to store information and instructions. For example, hard disk drives, an optical discs, an array of disks such as Redundant Array of Independent Disks (RAID), or other mass storage devices.

Bus 802 communicatively couples processor(s) 804 with the other memory, storage, and communications blocks. Bus 802 can be a PCI/PCI-X, SCSI, a Universal Serial Bus (USB) based system bus (or other) depending on the storage devices used and the like. Removable storage media 810 can be any kind of external storage, including hard-drives, floppy drives, USB drives, Compact Disc-Read-Only Memory (CD-ROM), Compact Disc-ReWritable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) that may be read by a computer, a processor or a like device. Such a medium may take many forms, including but not limited to non-volatile media, volatile media, and transmission media. Non-volatile media include for example, optical or magnetic disks and other persistent memory. Volatile media include dynamic random access memory, which typically constitutes the computer's main memory. Transmission media include coaxial cables, copper wire, and fiber optics, including the wires that comprise a system bus coupled to the processor. Transmission media may include or convey acoustic waves, light waves, and electromagnetic emissions, such as those generated during radio frequency (RF) and infrared (IR) data communications.

The machine-readable medium may include but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other types of media/machine-readable medium suitable for storing electronic instructions. Moreover, embodiments herein may also be downloaded as a computer program product. The program may be transferred from a remote computer to a requesting computer by way of data signals embodied in a carrier wave or other propagation medium via a communication link (e.g., modem or network connection).

Various forms of computer-readable media may carry data (e.g., sequences of instructions) to a processor. For example, data may be (i) delivered from RAM to a processor; (ii) carried over a wireless transmission medium; (iii) formatted and/or transmitted according to numerous formats, standards, or protocols; and/or (iv) encrypted in any of a variety of ways well known in the art.

A computer-readable medium can store (in any appropriate format) the appropriate program elements to perform the methods.

As shown, main memory 806 is encoded with application(s) 822 that support(s) the functionality as discussed herein (the application(s) 822 may be an application(s) that provides some or all of the functionality of the services/mechanisms described herein). Application(s) 822 (and/or other resources as described herein) can be embodied as software code such as data and/or logic instructions (e.g., code stored in the memory or on another computer-readable medium such as a disk) that supports processing functionality according to different embodiments described herein.

During operation of one embodiment, processor(s) 804 accesses main memory 806 via bus 802 to launch, run, execute, interpret, or otherwise perform the logic instructions of the application(s) 822. Execution of application(s) 822 produces processing functionality of the service related to the application(s). In other words, the process(es) 824 represent one or more portions of the application(s) 822 performing within or upon the processor(s) 804 in the computer system 800.

It should be noted that in addition to the process(es) 824 that carries(carry) out operations as discussed herein, other embodiments herein include the application 822 itself (i.e., the unexecuted or non-performing logic instructions and/or data). The application 822 may be stored on a computer-readable medium (e.g., a repository) such as a disk or in an optical medium. According to other embodiments, the application 822 can also be stored in a memory type system such as in firmware, read-only memory (ROM), or, as in this example, as executable code within the main memory 806 (e.g., within Random Access Memory or RAM). For example, application(s) 822 may also be stored in removable storage media 810, read-only memory 808, and/or mass storage device 812.

Those skilled in the art will understand that computer system 800 can include other processes and/or software and hardware components, such as an operating system that controls the allocation and use of hardware resources.

As discussed herein, embodiments of the present invention include various steps or operations. A variety of these steps may be performed by hardware components or embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, including hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

### CONCLUSION

Where a process is described herein, those of ordinary skill in the art will appreciate that the process may operate without any user intervention. In another embodiment, the process includes some human intervention (e.g., an act is performed by or with the assistance of a human).

As used herein, including in the claims, the phrase “at least some” means “one or more” and includes the case of only one. Thus, e.g., the phrase “at least some ABCs” means “one or more ABCs” and includes the case of only one ABC.

As used herein, including in the claims, the term “at least one” should be understood as meaning “one or more,” and therefore includes both embodiments that include one or multiple components. Furthermore, dependent claims that refer to independent claims that describe features with “at least one” have the same meaning, both when the feature is referred to as “the” and “the at least one.”

As used herein, including in the claims, the phrase “using” means “using at least” and is not exclusive. Thus, e.g., the phrase “using x” means “using at least x.” Unless specifically stated by the use of the word “only,” the phrase “using x” does not mean “using only x.”

As used herein, including in the claims, the phrase “based on” means “based in part on” or “based, at least in part, on” and is not exclusive. Thus, e.g., the phrase “based on factor x” means “based in part on factor x” or “based, at least in part, on factor x.” Unless specifically stated by the use of the word “only,” the phrase “based on x” does not mean “based only on x.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “x is distinct from Y” means that “x is at least partially distinct from Y” and does not mean that “x is fully distinct from Y.” Thus, as used herein, including in the claims, the phrase “x is distinct from Y” means that x differs from Y in at least some way.

It should be appreciated that the words “first,” “second,” and so on in the description and claims are used to distinguish or identify and not to show a serial or numerical limitation. Similarly, letter labels (e.g., “(A),” “(B),” “(C),” and so on, or “(a),” “(b),” and so on) and/or numbers (e.g., “(i),” “(ii),” and so on) are used to assist in readability and to help distinguish and/or identify and are not intended to be otherwise limiting or to impose or imply any serial or numerical limitations or orderings. Similarly, words such as “particular,” “specific,” “certain,” and “given” in the description and claims, if used, are to distinguish or identify and are not intended to be otherwise limiting.

As used herein, including in the claims, the terms “multiple” and “plurality” mean “two or more” and include the case of “two.” Thus, e.g., the phrase “multiple ABCs” means “two or more ABCs” and includes “two ABCs.” Similarly, e.g., the phrase “multiple PQRs,” means “two or more PQRs,” and includes “two PQRs.”

The present invention also covers the exact terms, features, values, and ranges, etc., in case these terms, features, values, and ranges, etc. are used in conjunction with terms such as about, around, generally, substantially, essentially, at least, etc. (for example, “about 3” or “approximately 3” shall also cover exactly 3 or “substantially constant” shall also cover exactly constant).

As used herein, including in the claims, singular forms of terms are to be construed as also including the plural form and vice versa unless the context indicates otherwise. Thus, it should be noted that as used herein, the singular forms “a,” “an,” and “the” include plural references unless the context clearly dictates otherwise.

Throughout the description and claims, the terms “comprise,” “including,” “having,” and “contain” and their variations should be understood as meaning “including but not limited to” and are not intended to exclude other components unless specifically so stated.

It will be appreciated that variations to the embodiments of the invention can be made while still falling within the scope of the invention. Alternative features serving the same, equivalent, or similar purpose can replace features disclosed in the specification unless stated otherwise. Thus, unless stated otherwise, each feature disclosed represents one example of a generic series of equivalent or similar features.

Use of exemplary language, such as “for instance,” “such as,” “for example” (“e.g.,”) and the like, is merely intended to illustrate the invention better and does not indicate a limitation on the scope of the invention unless specifically so claimed. The abbreviation “i.e.” means “that is.”

While a particular feature of the invention may have been disclosed with respect to only one of several implementations, such feature may be combined with one or more other features of the other implementations as may be desired and advantageous for any given or particular application. Furthermore, to the extent that the terms “includes,” “including,” and variants thereof are used in either the detailed description or the claims, these terms are intended to be inclusive in a manner similar to the term “comprising.”

While the invention has been described in connection with what is presently considered to be the most practical and preferred embodiments, it is to be understood that the invention is not to be limited to the disclosed embodiment but, on the contrary, is intended to cover various modifications and equivalent arrangements included within the spirit and scope of the appended claims.

### APPENDIX A

### Full Recipe Format in Schema.Org JSON-LD

```
{
  “@context”:“http://schema.org/”,
  “@type”:“Recipe”,
  “name”:“Roasted Fennel with Garlic & Herbs”,
  “author”:{
    “@type”:“Person”,
    “name”:“Every Last Bite”
  },
  “description”:“An easy-to-prepare side dish, the Roasted Fennel is
buttery, caramelized on the edges, and deliciously sweet in flavor.
(Whole30, Vegan &amp; Keto)”,
  “datePublished”:“2020-04-24T12:33:23+00:00”,
  “image”:[
    “https://www.everylastbite.com/wp-content/uploads/2020/04/DSC_0084-2-
scaled.jpg”,
    “https://www.everylastbite.com/wp-content/uploads/2020/04/DSC_0084-2-
500x500.jpg”,
    “https://www.everylastbite.com/wp-content/uploads/2020/04/DSC_0084-2-
500x375.jpg”,
    “https://www.everylastbite.com/wp-content/uploads/2020/04/DSC_0084-2-
480x270.jpg”
  ],
  “recipeYield”:[
    “4”
  ],
  “prepTime”:“PT8M”,
  “cookTime”:“PT35M”,
  “totalTime”:“PT43M”,
  “recipeIngredient”:[
    “2 large bulbs fennel”,
    “3 tbsp olive oil”,
    “2 cloves garlic (minced)”,
    “3/4 tsp salt”,
    “1 tsp black pepper”,
    “1 tsp thyme”,
    “1/4 cup parmesan ((omit if Dairy Free/Paleo/Vegan))”
  ],
  “recipeInstructions”:[
    {
    “@type”:“HowToStep”,
    “text”:“Preheat the oven to 400 degrees Fahrenheit (205 degrees
Celsius)”,
    “name”:“Preheat the oven to 400 degrees Fahrenheit (205 degrees
Celsius)”,
    “url”:“https://www.everylastbite.com/roasted-fennel/#wprm-recipe-
21234-step-0-0”
    },
    {
    “@type”:“HowToStep”,
    “text”:“Remove any of the stalks from the fennel bulbs and then cut
them in half lengthwise. Cut each halved fennel bulb into 1/2 inch thick
slices and arrange the slices on a parchment paper-lined baking sheet,
ensuring that they are all laid out evenly and do not overlap.”,
    “name”:“Remove any of the stalks from the fennel bulbs and then cut
them in half lengthwise. Cut each halved fennel bulb into 1/2 inch thick
slices and arrange the slices on a parchment paper-lined baking sheet,
ensuring that they are all laid out evenly and do not overlap.”,
    “url”:“https://www.everylastbite.com/roasted-fennel/#wprm-recipe-
21234-step-0-1”
    },
    {
    “@type”:“HowToStep”,
    “text”:“In a bowl, combine the olive oil and minced garlic and brush
it over the sliced fennel and then sprinkle the thyme, salt, and pepper over
top to ensure they are all well-seasoned.”,
    “name”:“In a bowl, combine the olive oil and minced garlic and brush
it over the sliced fennel and then sprinkle the thyme, salt and pepper over
top to ensure they are all well-seasoned.”,
    “url”:“https://www.everylastbite.com/roasted-fennel/#wprm-recipe-
21234-step-0-2”
    },
    {
    “@type”:“HowToStep”,
    “text”:“Roast the fennel in the oven for 25 minutes. After 25
minutes, if using parmesan, sprinkle it over the fennel and then return the
tray to the oven to bake for another 10 minutes.”,
    “name”:“Roast the fennel in the oven for 25 minutes. After 25
minutes, if using parmesan, sprinkle it over the fennel and then return the
tray to the oven to bake for another 10 minutes.”,
    “url”:“https://www.everylastbite.com/roasted-fennel/#wprm-recipe-
21234-step-0-3”
    },
    {
    “@type”:“HowToStep”,
    “text”:“After 35 minutes of baking, the fennel should be tender and
caramelized on the edges (cook for another 5-8 minutes if it is not yet
tender). Serve warm.”,
    “name”:“After 35 minutes of baking, the fennel should be tender and
caramelized on the edges (cook for another 5-8 minutes if it is not yet
tender). Serve warm.”,
    “url”:“https://www.everylastbite.com/roasted-fennel/#wprm-recipe-
21234-step-0-4”
    }
  ],
  “aggregateRating”:{
    “@type”:“AggregateRating”,
    “ratingValue”:“4.8”,
    “ratingCount”:“15”
  },
  “recipeCategory”:[
    “Dairy Free”,
    “Gluten Free”,
    “Grain Free”,
    “Nut Free”,
    “Paleo”,
    “Specific Carbohydrate Diet Legal”,
    “Vegan”,
    “Whole30”
  ],
  “nutrition”:{
    “@type”:“NutritionInformation”,
    “calories”:“121 kcal”,
    “carbohydrateContent”:“1 g”,
    “proteinContent”:“2 g”,
    “fatContent”:“12 g”,
    “saturatedFatContent”:“2 g”,
    “cholesterolContent”:“4 mg”,
    “sodiumContent”:“537 mg”,
    “fiberContent”:“1 g”,
    “sugarContent”:“1 g”,
    “servingSize”:“1 serving”
  },
  “@id”:“https://www.everylastbite.com/roasted-fennel/#recipe”,
  “isPartOf”:{
    “@id”:“https://www.everylastbite.com/roasted-fennel/#article”
  },
  “mainEntityOfPage”:“https://www.everylastbite.com/roasted-
fennel/#webpage”
}
```

### APPENDIX B

### Example of Step Extraction

This section contains examples of the input and output data for the primary machine learning models for Step Extraction.

### Recognize Entities in Steps

Example Inputs and Corresponding Outputs (with Entity Type and Span)

| | |
|---|---|
| 1. | ‘Preheat oven to 375 degrees.‘ |

[{′text′: ′preheat′, ′entity′: ′CapabilityEvent′, ′start′: 0, ′end′: 7,
′id′: 1}, {′text′: ′375 degrees′, ′entity′: ′Temperature′, ′start′: 16,
′end′: 20, ′id′: 2}]

| | |
|---|---|
| 2. | ‘Heat butter in a skillet; add garlic and rice and cook until both |
| | are golden brown.‘ |

[{′text′: ′heat′, ′entity′: ′CapabilityEvent′, ′start′: 0, ′end′: 4, ′id′:
3}, {′text′: ′butter′, ′entity′: ′Ingredient′, ′start′: 5, ′end′: 11, ′id′:
4}, {′text′: ′garlic′, ′entity′: ′Ingredient′, ′start′: 30, ′end′: 36, ′id′:
5}, {′text′: ′rice′, ′entity′: ′Ingredient′, ′start′: 41, ′end′: 45, ′id′:
6}, {′text′: ′cook′, ′entity′: ′CapabilityEvent′, ′start′: 50, ′end′: 54,
′id′: 7}]

| | |
|---|---|
| 3. | ‘Add 1 cup of broth and the salt and pepper.‘ |

[{′text′: ′1 cup of broth′, ′entity′: ′Ingredient′, ′start′: 4, ′end′: 18,
′id′: 8}, {′text′: ′salt and pepper′, ′entity′: ′Ingredient′, ′start′: 27,
′end′: 42, ′id′: 9}]

| | |
|---|---|
| 4. | ‘Bring to a boil and pour into a covered casserole; bake for 25 |
| | minutes.‘ |

[{′text′: ′bake′, ′entity′: ′CapabilityEvent′, ′start′: 51, ′end′: 55, ′id′:
10}, {′text′: ′25 minutes′, ′entity′: ′Time′, ′start′: 60, ′end′: 70, ′id′:
11}]

| | |
|---|---|
| 5. | ‘Stir in remaining 1 1/2 cups broth; cook for another 45 |
| | minutes.‘ |

[{′text′: ′1 1/2 cups broth′, ′entity′:′Ingredient′, ′start′: 18, ′end′:
34, ′id′: 12}, {′text′: ′cook′, ′entity′: ′CapabilityEvent′, ′start′: 36,
′end′: 40, ′id′: 13}, {′text′: ′45 minutes′, ′entity′: ′Time′, ′start′: 53,
′end′: 63, ′id′: 14}]

### Find Entity Relationships

In these examples, the relation classifier is asked to determine if the two entities given are related. For each of the below, the classifier will return true or false. In the cases of true, the relation type is determined by the type of the entities.

### Example Input

| | |
|---|---|
| 1. | <e1>Preheat</e1> oven to <2>375*</e2>. Heat butter in a skillet; |
| | add garlic and rice and cook until both are golden brown. |
| 2. | <e1>Preheat</e1> oven to 375*. <<2>Heat</e2> butter in a skillet; |
| | add garlic and rice and cook until both are golden brown. |
| 3. | <e1>Preheat</e1> oven to 375*. Heat <e2>butter</e2> in a skillet; |
| | add garlic and rice and cook until both are golden brown. |
| 4. | <e1>Preheat</e1> oven to 375*. Heat butter in a skillet; add |
| | <e2>garlic</e2> and rice and cook until both are golden brown. |
| 5. | <e1>Preheat</e1> oven to 375*. Heat butter in a skillet; add garlic |
| | and <e2>rice</e2> and cook until both are golden brown. |
| 6. | <e1>Heat</e1> butter in a skillet; add garlic and rice and cook until |
| | both are golden brown. Add <e2>1 cup of broth</e2> and the salt |
| | and pepper. |
| 7. | <e1>Heat</e1> butter in a skillet; add garlic and rice and cook until |
| | both are golden brown. Add 1 cup of broth and the <e2>salt and |
| | pepper</e2>. |
| 8. | Heat <e1>butter</e1> in a skillet; add garlic and rice and cook until |
| | both are golden brown. Add <e2>1 cup of broth</e2> and the salt |
| | and pepper. |
| 9. | Add <e1>1 cup of broth</e1> and the salt and pepper. Bring to a boil |
| | and pour into a covered casserole; <e2>bake</e2> for 25 minutes. |
| 10. | Add <e1>1 cup of broth</e1> and the salt and pepper. Bring to a boil |
| | and pour into a covered casserole; bake for <e2>25 minutes</e2>. |
| 11. | Bring to a boil and pour into a covered casserole; <e1>bake</e1> for |
| | 25 minutes. Stir in remaining <e2>1 1/2 cups broth</e2>; cook for |
| | another 45 minutes. |
| 12. | Bring to a boil and pour into a covered casserole; <e1>bake</e1> for |
| | 25 minutes. Stir in remaining 1 1/2 cups broth; <e2>cook</e2> for |
| | another 45 minutes. |

### Entity Relation Recognition Model Output

The entity recognition and entity relation classification are combined, as in the following example:

[{‘text’: ‘Preheat oven to 375*. Heat butter in a skillet; add garlic and
rice and cook until both are golden brown.’, ‘relations’: [{‘ents’:
[‘Preheat’, ‘375*’], ‘ners’: {‘ent1’: ‘CapabilityEvent’, ‘ent1_span’: (0,
7), ‘ent2’: ‘Temperature’, ‘ent2_span’: (16, 20)}, ‘relation_id’:
‘HasTemperatureSetting’}, {‘ents’: [‘Heat’, ‘butter’], ‘ners’: {‘ent1’:
‘CapabilityEvent’, ‘ent1_span’: (22, 26), ‘ent2’: ‘Ingredient’,
‘ent2_span’: (27, 33)}, ‘relation_id’: ‘UsesIngredient’}, {‘ents’:
[‘garlic’, ‘cook’], ‘ners’: {‘ent1’: ‘Ingredient’, ‘ent1_span’: (52, 58),
‘ent2’: ‘CapabilityEvent’, ‘ent2_span’: (72, 76)}, ‘relation_id’:
‘UsesIngredient’}, {‘ents’: [‘rice’, ‘cook’], ‘ners’: {‘ent1’:span’:
(63, ‘Ingredient’, ‘ent1_67), ‘ent2’: ‘CapabilityEvent’, ‘ent2_span’:
(72, 76)}, ‘relation_id’: ‘Uses Ingredient’}]}]

### Resolve Capabilities to Knowledge Base

To know what capability is present, these must be disambiguated against a knowledge base of cooking capabilities. In a presently preferred embodiment, the knowledge base has on the order of 100 capabilities. Each span where a capability event has been found and surrounding text is classified by the disambiguation model.

### Input

| | |
|---|---|
| 1. | [START_ENT]Preheat[END_ENT] oven to 375*. Heat butter in a |
| | skillet; add garlic and rice and cook until both are golden brown. |
| 2. | Preheat oven to 375*. [START_ENT]Heat[END_ENT] butter in a |
| | skillet; add garlic and rice and cook until both are golden brown. Add |
| | 1 cup of broth and the salt and pepper. |
| 3. | Preheat oven to 375*. Heat butter in a skillet; add garlic and rice and |
| | [START_ENT]cook[END_ENT] until both are golden brown. Add |
| | 1 cup of broth and the salt and pepper. |
| 4. | Add 1 cup of broth and the salt and pepper. Bring to a boil and pour |
| | into a covered casserole; [START_ENT]bake[END_ENT] for 25 |
| | minutes. Stir in remaining 1 1/2 cups broth; cook for another 45 |
| | minutes. |
| 5. | Bring to a boil and pour into a covered casserole; bake for 25 |
| | minutes. Stir in remaining 1 1/2 cups broth; |
| | [START_ENT]cook[END_ENT] for another 45 minutes. |
| | This can be doubled without increasing the cooking time. |

### Disambiguation Model Output

| | |
|---|---|
| 1. | (‘Preheat oven to 375*.’, ‘Pre-Heat’) |
| 2. | (‘Heat butter in a skillet; add garlic and rice and cook until both are |
| | golden brown.’, ‘Sauté’) |
| 3. | (‘Heat butter in a skillet; add garlic and rice and cook until both are |
| | golden brown.’, ‘Heat’) |
| 4. | (‘Bring to a boil and pour into a covered casserole; bake for 25 |
| | minutes.’, ‘Bake’) |
| 5. | (‘Stir in remaining 1 1/2 cups broth; cook for another 45 minutes.’, |
| | ‘Bake’) |

### APPENDIX C: A CONNECTED (SMART) RECIPE

| 1 | prep_time: P0DT0H15M0S | |
|---|---|---|
| 2 | cook_time: P0DT0H10M0S | |
| 3 | total_time: P0DT0H25M0S | |
| 4 | name: Quick Chocolate Chip Cookies | |
| 5 | source_url: https://share.frescocooks.com/nnVON00sSqb | |
| 6 | description: Quick and easy cookies with the perfect hit of melting | |
| 7 | chocolate. | |
| 8 | difficulty: 2 | |
| 9 | ingredients: | |
| 10 | - | source_text: 140 g Unsalted butter |

| 11 | reference_ingredient_id: cckg:UnsaltedButter | |
|---|---|---|
| 12 | reference_preparation_ids: | |
| 13 | - | cckg:RoomTemperature |

| 14 | | quantity: |
|---|---|---|
| 15 | | amount: 145 |
| 16 | | reference_unit_id: cckg:Gram |
| 17 | - | source_text: 55 g Granulated sugar |
| 18 | | reference_ingredient_id: cckg:GranulatedSugar |
| 19 | | quantity: |
| 20 | | amount: 54 |
| 21 | | reference_unit_id: cckg:Gram |
| 22 | - | source_text: 140 g Brown sugar |
| 23 | | reference_ingredient_id: cckg:BrownSugar |
| 24 | | quantity: |
| 25 | | amount: 145 |
| 26 | | reference_unit_id: cckg:Gram |
| 27 | - | source_text: 1 Egg |
| 28 | | reference_ingredient_id: cckg:Egg |
| 29 | | quantity: |
| 30 | | amount: 50 |
| 31 | | reference_unit_id: cckg:Gram |
| 32 | - | source_text: 5 g Vanilla extract |
| 33 | | reference_ingredient_id: cckg:VanillaExtract |
| 34 | | quantity: |
| 35 | | amount: 5 |
| 36 | | reference_unit_id: cckg:Gram |
| 37 | - | source_text: 220 g All-purpose flour |
| 38 | | reference_ingredient_id: cckg: AllPurposeFlour |
| 39 | | quantity: |
| 40 | | amount: 218 |
| 1 | | reference_unit_id: cckg:Gram |
| 2 | - | source_text: 5 g Sea salt |
| 3 | | reference_ingredient_id: cckg:SeaSalt |
| 4 | | quantity: |
| 5 | | amount: 5 |
| 6 | | reference_unit_id: cckg:Gram |
| 7 | - | source_text: 5 g Baking soda |
| 8 | | reference_ingredient_id: cckg:BakingSoda |
| 9 | | quantity: |
| 10 | | amount: 5 |
| 11 | | reference_unit_id: cckg:Gram |
| 12 | - | source_text: 180 g Chocolate chips |
| 13 | | reference_ingredient_id: cckg: ChocolateChips |
| 14 | | quantity: |
| 15 | | amount: 181 |
| 16 | | reference_unit_id: cckg:Gram |
| 17 | steps: | |
| 18 | - | source_text: Add unsalted butter, granulated sugar and |

| | |
|---|---|
| 19 | brown sugar to a clean large mixing bowl |

| | |
|---|---|
| 20 | text: Add unsalted butter, granulated sugar and brown |

| | |
|---|---|
| 21 | sugar to a clean large mixing bowl |

| 22 | ingredients: | |
|---|---|---|
| 23 | - | ingredient_idx: 0 |
| 24 | | quantity: |
| 25 | | amount: 145 |
| 26 | | reference_unit_id: cckg:Gram |
| 27 | - | ingredient_idx: 1 |
| 28 | | quantity: |
| 29 | | amount: 54 |
| 30 | | reference_unit_id: cckg:Gram |
| 31 | - | ingredient_idx: 2 |

| | |
|---|---|
| 32 | quantity: |
| 33 | amount: 145 |
| 34 | reference_unit_id: cckg:Gram |

| 35 | - | source_text: Cream until smooth |
|---|---|---|
| 36 | | text: Cream until smooth |
| 37 | - | source_text: Add egg and vanilla extract to the dough |

| 38 | text: Add egg and vanilla extract to the dough | |
|---|---|---|
| 39 | ingredients: | |
| 40 | - | ingredient_idx: 3 |
| 41 | | quantity: |
| 42 | | amount: 50 |
| 1 | | reference_unit_id: cckg:Gram |
| 2 | - | ingredient_idx: 4 |

| | |
|---|---|
| 3 | quantity: |
| 4 | amount: 5 |
| 5 | reference_unit_id: cckg:Gram |

| 6 | - | source_text: Mix until well combined |
|---|---|---|
| 7 | | text: Mix until well combined |
| 8 | - | source_text: Add all-purpose flour, sea salt, and baking |

| | |
|---|---|
| 9 | soda to the dough |

| 10 | text: Add all-purpose flour, sea salt, and baking soda | |
|---|---|---|
| | to the dough | |
| 11 | ingredients: | |
| 12 | - | ingredient_idx: 5 |
| 13 | | quantity: |
| 14 | | amount: 218 |
| 15 | | reference_unit_id: cckg:Gram |
| 16 | - | ingredient_idx: 6 |
| 17 | | quantity: |
| 18 | | amount: 5 |
| 19 | | reference_unit_id: cckg:Gram |
| 20 | - | ingredient_idx: 7 |

| | |
|---|---|
| 21 | quantity: |
| 22 | amount: 5 |
| 23 | reference_unit_id: cckg:Gram |

| 24 | - | source_text: Mix until well blended |
|---|---|---|
| 25 | | text: Mix until well blended |
| 26 | - | source_text: Add chocolate chips to the dough |

| 27 | text: Add chocolate chips to the dough | |
|---|---|---|
| 28 | ingredients: | |
| 29 | - | ingredient_idx: 8 |

| | |
|---|---|
| 30 | quantity: |
| 31 | amount: 181 |
| 32 | reference_unit_id: cckg:Gram |

| 33 | - | source_text: Mix until just combined |
|---|---|---|
| 34 | | text: Mix until just combined |
| 35 | - | source_text: Chill in freezer |
| 36 | | text: Chill in freezer |
| 37 | - | source_text: Pre-heat oven - 175°C |
| 38 | | text: Pre-heat oven - 175°C |
| 39 | - | source_text: Line a clean baking sheet with parchment |
| | | paper |
| 40 | | text: Line a clean baking sheet with parchment paper |
| 41 | - | source_text: Scoop dough onto baking sheet |
| 42 | | text: Scoop dough onto baking sheet |
| 1 | - | source_text: Bake until golden brown - 11 min, 175°C |

| | |
|---|---|
| 2 | text: Bake until golden brown - 11 min, 175°C |
| 3 | capability: |
| 4 | reference_capability_id: cckg:Bake |
| 5 | settings: |

| | | |
|---|---|---|
| 6 | - | reference_setting_id: |
| | | cckg:TemperatureSetting |

| | |
|---|---|
| 7 | value: |
| 8 | type: number |
| 9 | value: 175 |
| 10 | reference_unit_id: cckg:Celsius |

| 11 | - | source_text: Let cool |
|---|---|---|
| 12 | | text: Let cool |
| 13 | - | source_text: Serve |

| | |
|---|---|
| 14 | text: Serve |

1-33. (canceled)

34. A method, in a system in which a recipe is stored on a recipe framework, the method comprising, by a user having one or more devices and one or more appliances:
a recipe program presenting recipe information to the user using a device interface on a first of said one or more devices and/or on an appliance interface of a first appliance of said one or more appliances;
tracking interactions of the user with the recipe program via the device interface or the appliance interface;
monitoring progress and state of the recipe;
based on said monitoring, maintaining in said recipe framework, a version of the progress and state of the recipe; and
while the recipe is in progress, and in response to the user switching to a second device of said one or more devices and/or to a second appliance of said one or more appliances, presenting recipe information on the second device and/or on the second appliance based on the version of the progress and state of the recipe maintained in the recipe framework, wherein the second device or second appliance obtains the version of the progress and state from the recipe framework.

35. The method of claim 34, wherein the version of the progress and state of the recipe maintained in the recipe framework is a true version of the progress and state of the recipe, and wherein, if there is a discrepancy between versions of the progress and state of the recipe, the progress and state maintained by the recipe framework will govern.

36. The method of claim 35, wherein the recipe framework is accessible via one or more interfaces, and wherein a device or appliance obtains the true version of the progress and state from the recipe framework via said one or more interfaces.

37. The method of claim 36, wherein the true version of the progress and state of the recipe is based on received streams of events and/or state data from the one or more devices and/or the one or more appliances, wherein state data from an appliance includes information about a current state of the appliance.

38. The method of claim 34, wherein the recipe comprises a list of one or more ingredients and a list of recipe steps, wherein the state of the progress and state of the recipe comprises information about which recipe step or steps have been completed.

39. The method of claim 34, wherein, when the user selects the recipe, the recipe framework determines which one or more appliances to use for the recipe based on (i) information about appliances available to the user, and (ii) user data maintained by the recipe framework, the user data including appliance data.

40. The method of claim 34, further comprising performing one or more of the following acts before steps and/or ingredients of the recipe are determined:
(i) calibration; (ii) recipe scaling; (iii) ingredient substitutions; (iv) nutritional information determination; (v) recommendations; and (vi) capability resolution.

41. The method of claim 40, wherein the recipe determines which of the one or more appliances are to be used, and wherein a determination of which of the one or more appliances are to be used is made after the acts of the method are performed.

42. The method of claim 34, wherein the one or more devices are selected from:
a personal computer, a cell phone, a tablet computer, a desktop computer, a TV, a smartwatch, a voice assistant, or an appliance UI; and
wherein the one or more appliances are selected from: cooking and food preparation appliances.

43. The method of claim 34, wherein the recipe was generated by one or more machine-learning algorithms.

44. The method of claim 43, wherein the recipe is a connected recipe that was generated based on an initial recipe.

45. The method of claim 44, wherein the initial recipe was a structured recipe, including initial recipe step data, and/or initial recipe ingredient data, and/or initial recipe appliance data.

46. The method of claim 45, wherein the connected recipe is a structured recipe and includes:
connected recipe step data and/or connected recipe ingredient data, and/or connected recipe appliance data.

47. The method of claim 46, wherein the connected recipe step data and/or connected recipe ingredient data was determined by the one or more machine-learning algorithms based on the initial recipe step data, and/or initial recipe ingredient data, and using a knowledge graph of culinary processes, ingredients, and measurement units.

48. The method of claim 46, wherein the one or more machine-learning algorithms comprise a machine learning (ML) pipeline, wherein the ML pipeline generates said connected recipe step data and/or said connected recipe ingredient data, and/or said connected recipe appliance data.

49. The method of claim 48, wherein said ML pipeline includes
a first model that recognizes culinary techniques and maps them to a knowledge graph of capabilities that an appliance can fulfill to annotate the connected recipe with capability events.

50. The method of claim 49, wherein the first model finds appliance-related parameters, wherein the appliance-related parameters comprise one or more of temperature, speed, time, and/or power.

51. The method of claim 49, wherein said ML pipeline further includes:
a third model that maps ambiguous capabilities to the knowledge graph of capabilities.

52. The method of claim 48, wherein said ML pipeline further includes:
a second model for relation classifications to determine which parameters relate to which capabilities.

53. The method of claim 34, carried out by a computer-implemented system comprising the one or more devices and the one or more appliances.
